(19) United States
(12) Patent Application Publication
(10) Pub. No.: US 2013/0102335 A1
(43) Pub. Date: Apr. 25, 2013

(54) MOBILE DEVICE, INFORMATION PROCESSING DEVICE, LOCATION INFORMATION ACQUISITION METHOD, LOCATION INFORMATION ACQUISITION SYSTEM, AND PROGRAM

(71) Applicant: Sony Corporation, Tokyo (JP)

(72) Inventors: Masanobu KATAGI, Kanagawa (JP); Masakazu UKITA, Kanagawa (JP); Shiho MORIAI, Kanagawa (JP)

(73) Assignee: Sony Corporation, Tokyo (JP)

(21) Appl. No.: 13/654,827

(22) Filed: Oct. 18, 2012

(30) Foreign Application Priority Data
Oct. 25, 2011 (JP) 2011-233625

(51) Int. Cl. H04W 24/00

(52) U.S. Cl. 455/457; 455/456.1

(57) ABSTRACT

There is provided a mobile device including an identification information acquisition section which acquires first identification information from an approaching mobile device, a location information acquisition section which acquires location information of a current point at a time point at which the first identification information is acquired, and a transmission section which transmits the first identification information and the location information in association with each other to an external device.

### BACKGROUND

The present disclosure relates to a mobile device, an information processing device, a location information acquisition method, a location information acquisition system, and a program.

In recent years, services using location information have been in widespread use. For example, there is an imaging device which has a positioning function and is capable of tagging location information to a photograph that has been taken. In this way, by tagging the location information to the photograph, photographs can be arranged using the location information as a key. Further, there is provided a service for parents to watch over their children as to where they are at the present moment, by letting each child carry a device having the positioning function.

Location information of a user or an object is acquired by a positioning function of a terminal device that is mainly carried by the user or with the object. Not many comments have been made on the reliability of the location information. For example, in the location authentication system disclosed in JP 2009-38586A, a vehicle acquires identification information from a road-side unit installed at an infrastructure facility such as a traffic light, a telegraph pole, a road, or a building, and transmits, to a location information management center, the identification information together with positioning information obtained by GPS measurement. The identification information includes the location information of the road-side unit and the time at which the identification information is acquired. The location information management center compares the location information and the time included in the identification information with the location information and the time included in the positioning information, and thus can confirm that the location information of the vehicle is correct.

### SUMMARY

However, even in the location authentication system disclosed in the above-mentioned JP 2009-38586A, nothing is taken into consideration about the possibility that a user may falsify the location information. That is, since the identification information for authenticating the location information of the vehicle was transmitted by the vehicle, it was easy for the user who wanted to falsify the location information to do so.

In light of the foregoing, it is desirable to provide a mobile device, an information processing device, a location information acquisition method, a location information acquisition system, and a program, which are novel and improved, and which are capable of reducing the possibility of the location information being falsified and capable of enhancing the reliability of the location information.

According to an embodiment of the present disclosure, there is provided a mobile device which includes an identification information acquisition section which acquires first identification information from an approaching mobile device, a location information acquisition section which acquires location information of a current point at a time point at which the first identification information is acquired, and a transmission section which transmits the first identification information and the location information in association with each other to an external device.

According to such a configuration, location information of a first mobile device is acquired by a second mobile device and is collected in the external device. Therefore, it becomes difficult for a user of the first mobile device to falsify his/her own location information, and the reliability of the location information is enhanced.

According to another embodiment of the present disclosure, there is provided an information processing device which includes a reception section which receives first identification information that is acquired by a second mobile device from an approaching first mobile device and that identifies the first mobile device, and location information of a time point at which the first identification information is acquired by the second mobile device, and a recording section which records the received first identification information and the received location information.

According to another embodiment of the present disclosure, there is provided a location information acquisition method which includes acquiring first identification information from an approaching mobile device, acquiring location information of a current point at a time point at which the first identification information is acquired, and transmitting the first identification information and the location information in association with each other to an external device.

According to another embodiment of the present disclosure, there is provided a location information acquisition system which includes a first mobile device, a second mobile device including an identification information acquisition section which acquires first identification information from the first mobile device that is approaching, a location information acquisition section which acquires location information of a current point at a time point at which the first identification information is acquired, and a transmission section which transmits the first identification information and the location information in association with each other, and an information processing device including a reception section which receives the first identification information and the location information transmitted by the second mobile device, and a recording section which records the first identification information and the location information.

According to another embodiment of the present disclosure, there is provided a program for causing a computer to function as a mobile device including an identification information acquisition section which acquires first identification information from an approaching mobile device, a location information acquisition section which acquires location information of a current point at a time point at which the first identification information is acquired, and a transmission section which transmits the first identification information and the location information in association with each other to an external device.

According to the embodiments of the present disclosure described above, the possibility of the location information being falsified can be reduced, and the reliability of the location information can be enhanced.

### BRIEF DESCRIPTION OF THE DRAWINGS

FIG. 1 is a first explanatory diagram showing an outline of a location information acquisition system according to an embodiment of the present disclosure;

FIG. 2 is a second explanatory diagram showing the outline of the location information acquisition system according to the embodiment;

FIG. 3 is a third explanatory diagram showing the outline of the location information acquisition system according to the embodiment;

FIG. 4 is a block diagram showing a functional configuration of a mobile device according to a first embodiment of the present disclosure;

FIG. 5 is a table showing an example of location information collected by a mobile device 10B according to the embodiment;

FIG. 6 is a block diagram showing a functional configuration of a location information server according to the embodiment;

FIG. 7 is a sequence diagram showing operation performed by a location information acquisition system according to the embodiment;

FIG. 8 is a block diagram showing a functional configuration of a mobile device according to a second embodiment of the present disclosure;

FIG. 9 is a block diagram showing a functional configuration of a location information server according to the embodiment;

FIG. 10 is a table showing an example of data stored in a location information database of the location information server according to the embodiment;

FIG. 11 is a sequence diagram showing operation performed by a location information acquisition system according to the embodiment;

FIG. 12 is a block diagram showing a functional configuration of a location information server according to a third embodiment of the present disclosure;

FIG. 13 is a sequence diagram showing operation performed by a location information acquisition system according to the embodiment;

FIG. 14 is a block diagram showing a functional configuration of a location information server according to a fourth embodiment of the present disclosure;

FIG. 15 is a sequence diagram showing operation performed by a location information acquisition system according to the embodiment;

FIG. 16 is an explanatory diagram showing an outline of a location information acquisition system according to a fifth embodiment of the present disclosure;

FIG. 17 is a block diagram showing a functional configuration of a location information server according to the embodiment;

FIG. 18 is a block diagram showing a functional configuration of a mobile device according to a sixth embodiment of the present disclosure;

FIG. 19 is a block diagram showing a functional configuration of a location information server according to the embodiment;

FIG. 20 is a sequence diagram showing operation performed by a location information acquisition system according to the embodiment;

FIG. 21 is a block diagram showing a hardware configuration example of the mobile device according to the first to sixth embodiments of the present disclosure; and

FIG. 22 is a block diagram showing a hardware configuration example of the location information server according to the first to sixth embodiments of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Outline

2. First Embodiment
2-1. Functional Configuration
2-2. Operation Example

3. Second Embodiment (Example of calculating location reliability)
3-1. Functional Configuration
3-2. Operation Example

4. Third Embodiment (Example of controlling location acquisition area)
4-1. Functional Configuration
4-2. Operation Example

5. Fourth Embodiment (Example of providing prediction information of location-acquirable area)
5-1. Functional Configuration
5-2. Operation Example

6. Fifth Embodiment (Example of using temporary ID)
6-1. Outline
6-2. Functional Configuration

7. Sixth Embodiment (Example of using encoding)
7-1. Functional Configuration
7-2. Operation Example

8. Hardware Configuration

9. Conclusion

### 1. Outline

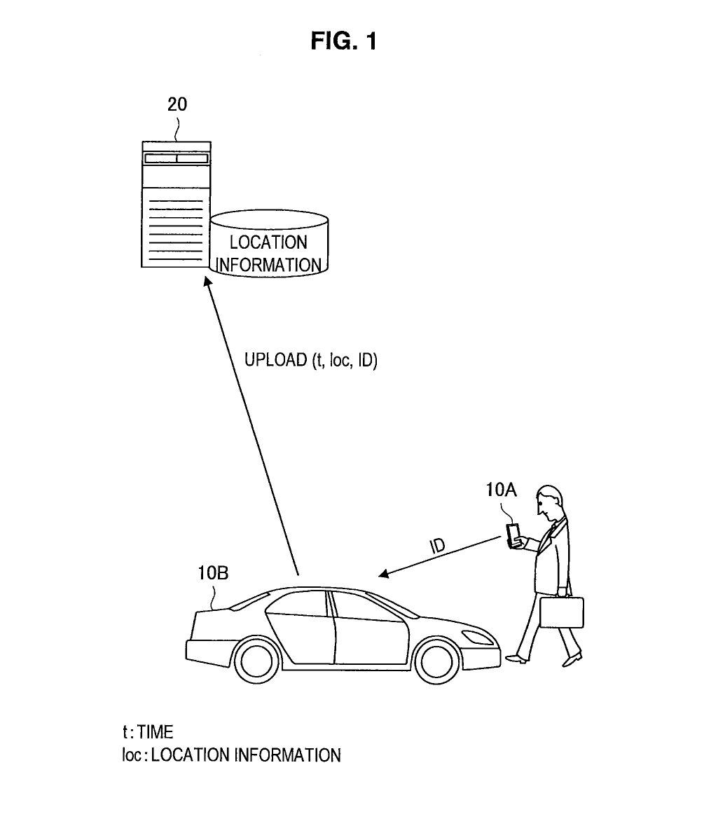

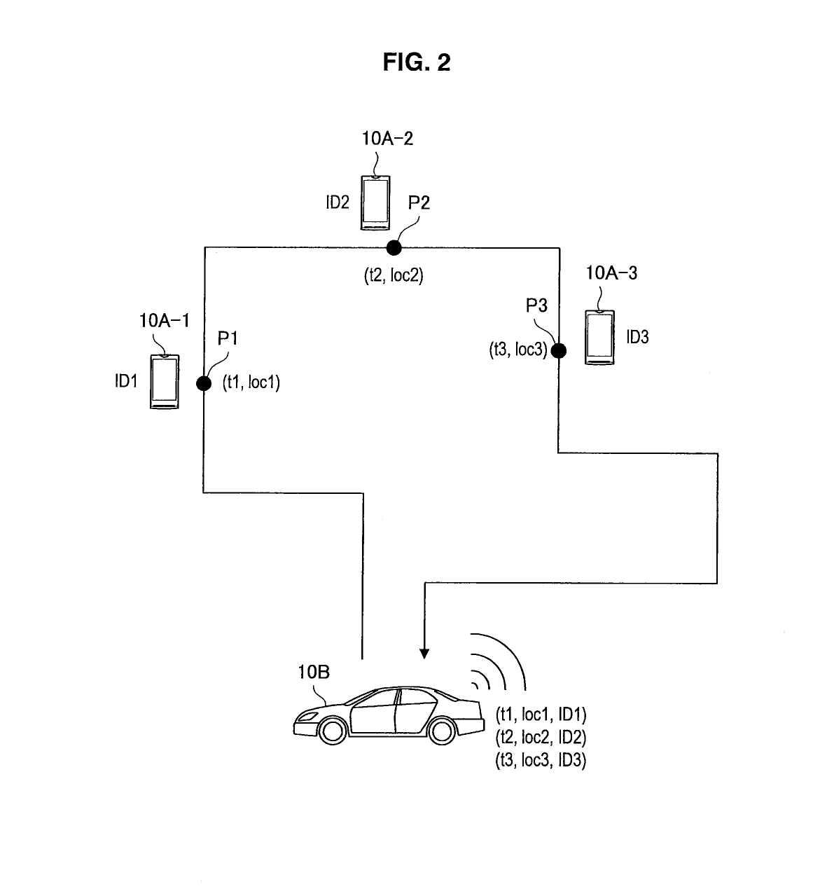

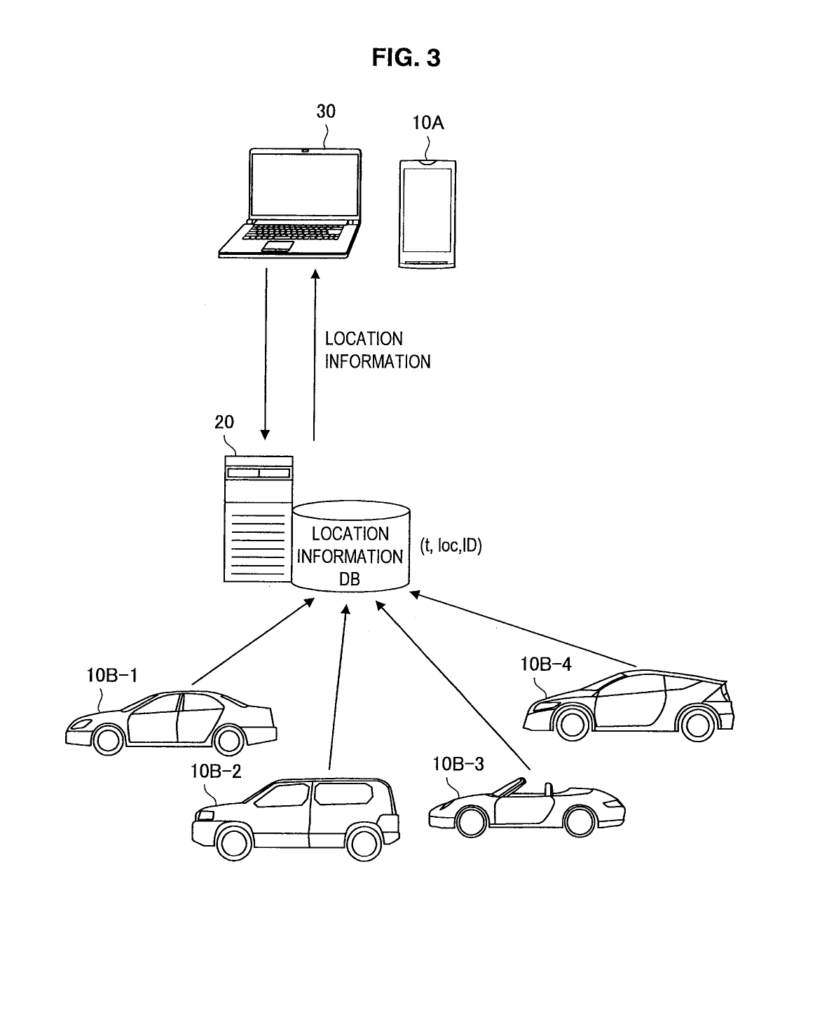

First, with reference to FIGS. 1 to 3, an outline of a location information acquisition system according to an embodiment of the present disclosure will be described. FIG. 1 is a first explanatory diagram showing an outline of a location information acquisition system according to an embodiment of the present disclosure. FIG. 2 is a second explanatory diagram showing the outline of the location information acquisition system according to the embodiment. FIG. 3 is a third explanatory diagram showing the outline of the location information acquisition system according to the embodiment.

First, refer to FIG. 1. As described above, the method is not a perfect one, in which the reliability of location information is guaranteed using only the information transmitted by a device managed by the user himself/herself, in the case where there exists a malicious user, that is, the user attempting to falsify the location information. Accordingly, the location information acquisition system suggested here acquires location information of a first mobile device 10A using a second mobile device 10B. The first mobile device 10A (here, a mobile phone carried by the user) which desires to acquire the location information transmits a first identification information ID for specifying the first mobile device 10A when approaching the second mobile device 10B (here, a navigation device mounted on a vehicle) having a positioning function. Here, the state in which the first mobile device 10A approaches the second mobile device 10B represents a case where the user and the vehicle pass each other, a case where the vehicle comes up from behind and passes the user, or the like. The second mobile device 10B which has acquired the first identification information ID acquires location information loc at time t at which the first identification information ID is acquired. After that, the second mobile device 10B sets the acquired location information as the location information of the first mobile device 10A, and uploads the acquired time t, location information loc, and first identification information ID to a location information server 20.

According to such a configuration, the location information of the first mobile device 10A is acquired by the second mobile device 10B and is stored in the location information server 20. Therefore, the possibility that the user of the first mobile device 10A may falsify the location information is reduced.

Note that the second mobile device 10B can acquire the first identification information ID each time the second mobile device 10B approaches the first mobile device 10A while moving. For example, as shown in FIG. 2, let us assume the case where the second mobile device 10B passes a first mobile device 10A-1 at a point P1 at time t1 while moving, passes a first mobile device 10A-2 at a point P2 at time t2, and passes a first mobile device 10A-3 at a point P3 at time t3. In this case, the second mobile device 10B acquires first identification information ID1 of the first mobile device 10A-1 at the point P1, and acquires the time t1 and location information loc1 at that time point. Further, after that, the second mobile device 10B acquires first identification information ID2 of the first mobile device 10A-2 at the point P2, and acquires the time t2 and location information loc2 at that time point. Further, after that, the second mobile device 10B acquires first identification information ID3 of the first mobile device 10A-3 at the point P3, and acquires the time t3 and location information loc3 at that time point.

The second mobile device 10B may transmit the acquired time t, location information loc, and first identification information ID to the location information server 20 each time the acquisition is performed. Alternatively, the second mobile device 10B may acquire and accumulate multiple pieces of time t, location information loc, and first identification information ID, and may transmit those collectively to the location information server 20.

Next, refer to FIG. 3. The location information server 20 can store pieces of location information transmitted from multiple second mobile devices 10B. Then, the location information server 20 can provide the acquired location information in response to a request from the user of the first mobile device 10A. In this case, the location information server 20 can provide the first mobile device 10A with the location information. Further, the location information server 20 may also provide another information processing device 30, which is associated with the user of the first mobile device 10A, with the location information.

For example, the second mobile device 10B may be mounted on a vehicle that travels in a manner that covers a specific area, such as a car for car-sharing and a taxi. Alternatively, the second mobile device 10B may also be mounted on public transport such as a bus and a train. In this way, by using the second mobile device 10B mounted on the vehicle for acquiring the location information, there is an advantage in that the cost necessary for introducing the system is reduced compared to the method in which a device installed at an infrastructure facility such as a traffic light, a telegraph pole, a road, or a building, is used, since it is not necessary to conduct investigation accompanying installation location determination. Further, in this case, there is also an advantage in that the system can be introduced at operators' own responsibility, who operate car-sharing, taxi, bus, train, or the like. Further, in the case of using the devices installed at infrastructure facilities, it is necessary that the maintenance of the devices is performed by visiting the respective infrastructure facilities. However, the present technology is preferred, since the second mobile devices 10B are each mounted on a vehicle, the maintenance can be performed by gathering the second mobile devices 10B in a specific place such as a garage.

Heretofore, there has been described the basic functional outline common to the location information acquisition systems according to respective embodiments of the present disclosure. Hereinafter, each embodiment will be described in detail.

### 2. First Embodiment

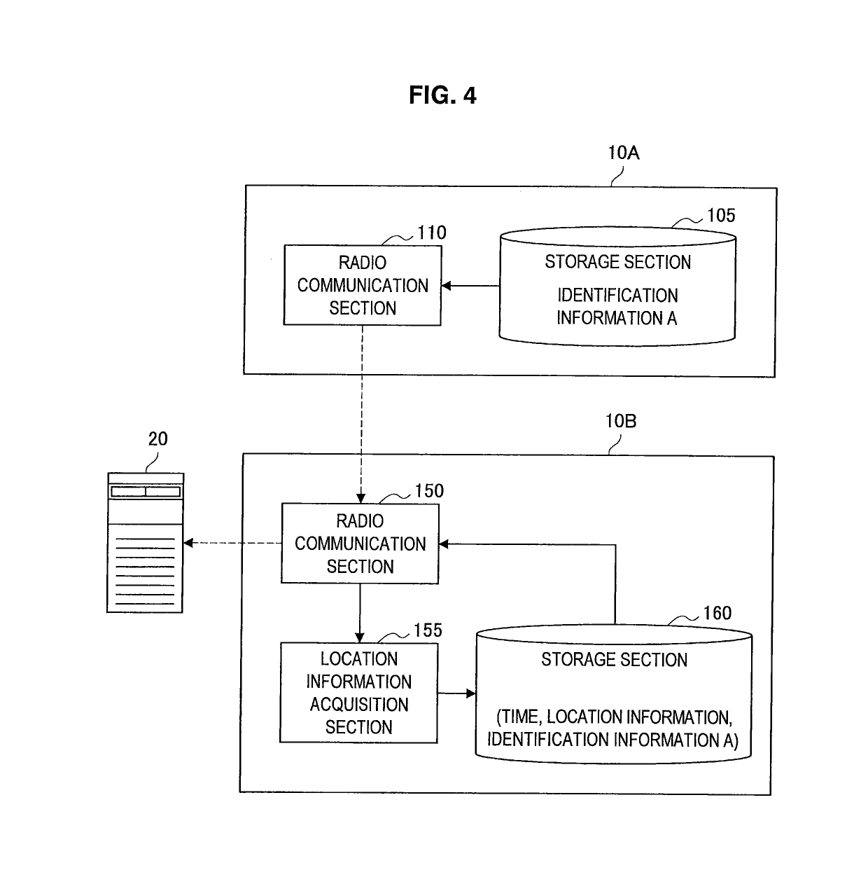

First, with reference to FIGS. 4 to 7, a first embodiment of the present disclosure will be described. In the first embodiment, there will be described a specific configuration example for realizing the basic functions explained in the outline of the location information acquisition system.

[2-1. Functional Configuration]

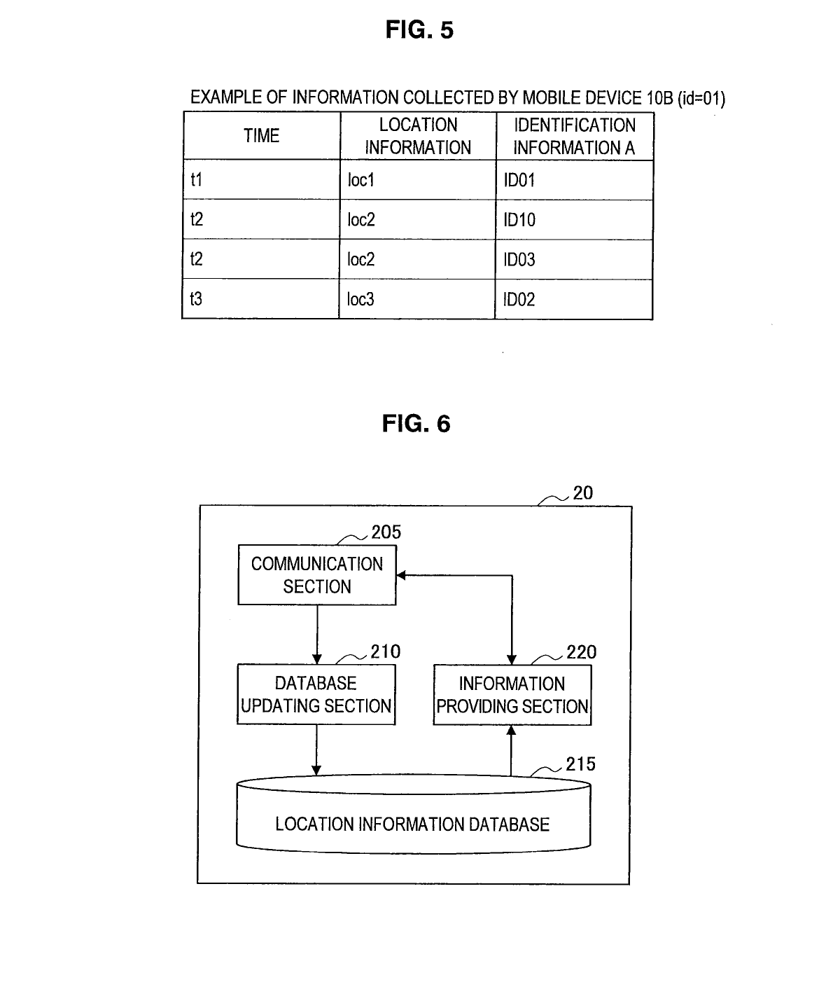

Here, with reference to FIGS. 4 to 6, there will be described functional configurations of a first mobile device 10A, a second mobile device 10B, and a location information server 20 included in a location information acquisition system according to the first embodiment of the present disclosure. FIG. 4 is a block diagram showing a functional configuration of a mobile device according to a first embodiment of the present disclosure. FIG. 5 is a table showing an example of location information collected by a mobile device 10B according to the embodiment. FIG. 6 is a block diagram showing a functional configuration of a location information server according to the embodiment.

### ((First Mobile Device 10A))

Referring to FIG. 4, the first mobile device 10A according to the first embodiment of the present disclosure includes a storage section 105 and a radio communication section 110. The first mobile device 10A may be a portable information processing device such as a mobile phone. Further, the first mobile device 10A may be a wireless tag, for example.

(Storage Section 105)

The storage section 105 can store identification information A which identifies the first mobile device 10A. Note that the identification information A is used synonymously with the first identification information ID. The storage section 105 is a device for storing data, and can include a storage medium, a recording device for recording data in the storage medium, a reading device for reading the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

(Radio Communication Section 110)

The radio communication section 110 is a communication device for establishing a wireless connection to an external device. The radio communication section 110 can be connected to the second mobile device 10B, for example. In establishing a connection with the second mobile device 1013, the radio communication section 110 can perform search processing for searching for the second mobile device 10B to be connected to. For example, the radio communication section 110 can detect a signal for the search that is transmitted by the second mobile device 10B. The radio communication section 110 can transmit the identification information A to the detected second mobile device 10B.

### ((Second Mobile Device 10B))

The second mobile device 10B mainly includes a radio communication section 150, a location information acquisition section 155, and a storage section 160. Here, let us assume that the second mobile device 10B is a navigation device mounted on a vehicle.

(Radio Communication Section 150)

The radio communication section 150 is a communication device for establishing a wireless connection to an external device. The radio communication section 150 can be connected to the first mobile device 10A, for example. The radio communication section 150 can perform search processing for searching for the first mobile device 10A to be connected to. For example, the radio communication section 150 can notify the first mobile device 10A of the presence of the second mobile device 10B by continually transmitting signals that can be detected by the first mobile device 10A. Then, the radio communication section 150 can receive the identification information A from the first mobile device 10A to which the radio communication section 150 is connected. Accordingly, the radio communication section 150 can function as an identification information acquisition section which acquires the identification information A from the approaching first mobile device 10A. When receiving the identification information A from the first mobile device 10A, the radio communication section 150 can notify the location information acquisition section 155 of the received identification information A.

Further, the radio communication section 150 can also be connected to the location information server 20. The radio communication section 150 can function as a transmission section which transmits the following in association with each other to the location information server 20, for example: the identification information A received from the first mobile device 10A; the location information acquired by the location information acquisition section 155 at the time at which the identification information A is received; and time of the time point at which the location information is acquired. The radio communication section 150 may transmit the generated information to the location information server 20 each time the identification information A is received. Alternatively, the radio communication section 150 may regularly transmit the generated multiple pieces of information collectively to the location information server 20.

(Location Information Acquisition Section 155)

The location information acquisition section 155 has a function of acquiring current location information. When the location information acquisition section 155 is notified of the received identification information A by the radio communication section 150, the location information acquisition section 155 can acquire the location information of the current point at the time point at which the identification information A is received. When receiving the location information, the location information acquisition section 155 can store, in the storage section 160, the identification information A, the location information, and the time at which the location information is acquired in association with each other.

Note that, as typical technology used for acquiring location information, there is exemplified a configuration using positioning satellites. The location information acquisition section 155 may be realized by a global positioning system (GPS) antenna and a GPS processing section which calculates location information from a GPS reception signal, for example. Alternatively, the location information acquisition section 155 may have a function of measuring a relative location using various types of sensors. Further, the location information acquisition section 155 may estimate, based on reception strengths of Wi-Fi radio waves received from multiple base stations, distances between the respective base stations and the second mobile device 10B, and may calculate the current location information based on the triangulation principle using the estimated distances and the pieces of location information of the respective base stations.

Further, although the GPS is used as an example of the positioning satellite in the above description, the positioning satellite is of course not limited to the GPS. The positioning satellite may be various types of positioning satellites such as Galileo, GLONASS, COMPASS, and MICHIBIKI. In this case, one type of positioning satellite may be used, or positioning signals obtained from multiple types of satellites may be used in combination. The configuration to be used for acquiring location information may be changed appropriately in accordance with the technical level each time when the present technology is carried out.

(Storage Section 160)

The storage section 160 has a function of temporarily storing the identification information A received from the first mobile device 10A, the location information at the time point at which the identification information A is acquired, and time at which the location information is acquired in association with each other. The storage section 160 is a device for storing data, and can include a storage medium, a recording device for recording data in the storage medium, a reading device for reading the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

Here, with reference to FIG. 5, there will be described an example of information collected by the second mobile device 10B according to the present embodiment. As is shown here, the second mobile device 10B can collect pieces of identification information A from multiple first mobile devices 10A, and can generate location information.

### ((Location Information Server 20))

Next, with reference to FIG. 6, there will be described a functional configuration of the location information server 20. The location information server 20 has a function of forming a location information database by collecting location information of the first mobile device 10A, and also providing the user associated with the first mobile device 10A with location information stored in the location information database.

The location information server 20 mainly includes a communication section 205, a database updating section 210, a location information database 215, and an information providing section 220.

(Communication Section 205)

The communication section 205 is a communication device for establishing a connection to a network, and is, for example, a wired or wireless local area network (LAN), Bluetooth (registered trademark), a communication card for a wireless USB (WUSB), a router for optical communication, a router for an asymmetric digital subscriber line (ADSL), or a modem for various communications. Further, the network connected to the communication section 205 is configured from a network and the like, which is connected via wire or wirelessly, and may be, for example, the Internet, a home-use LAN, infrared communication, visible light communication, broadcasting, and satellite communication.

When receiving information including the location information from the second mobile device 10B, the communication section 205 can supply the database updating section 210 with the received information. Further, the communication section 205 can function as a transmission section which transmits location information in response to a location query from the first mobile device 10A or the information processing device 30 associated with the first mobile device 10A.

(Database Updating Section 210)

The database updating section 210 has a function of updating a database based on the information received from the second mobile device 10B via the communication section 205. The database updating section 210 can add the information received from the second mobile device 10B to the location information database 215.

(Location Information Database 215)

The location information database 215 is a device for storing data, which stores location information of the first mobile device 10A. The location information database 215 can include a storage medium, a recording device for recording data in the storage medium, a reading device for reading the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

(Information Providing Section 220)

The information providing section 220 can provide, in response to a location information-query from a user, the location information of the first mobile device 10A specified by appropriate identification information A. For example, the information providing section 220 can provide the location information in accordance with a location information-query condition. For example, the location information to be required varies depending on the function of the application in which the location information is used. For example, in the case where the location information at specific time is required, the information providing section 220 can acquire, from among pieces of location information of the first mobile device 10A specified by designated identification information A, the location information loc of the specific time, and can provide the location information loc. Further, in the case where a specific period is designated by the location information query condition, the information providing section 220 can acquire multiple pieces of location information loc that are included in the specific period from among pieces of location information of the first mobile device 10A specified by designated identification information A, and can provide the multiple pieces of location information loc.

[2-2. Operation Example]

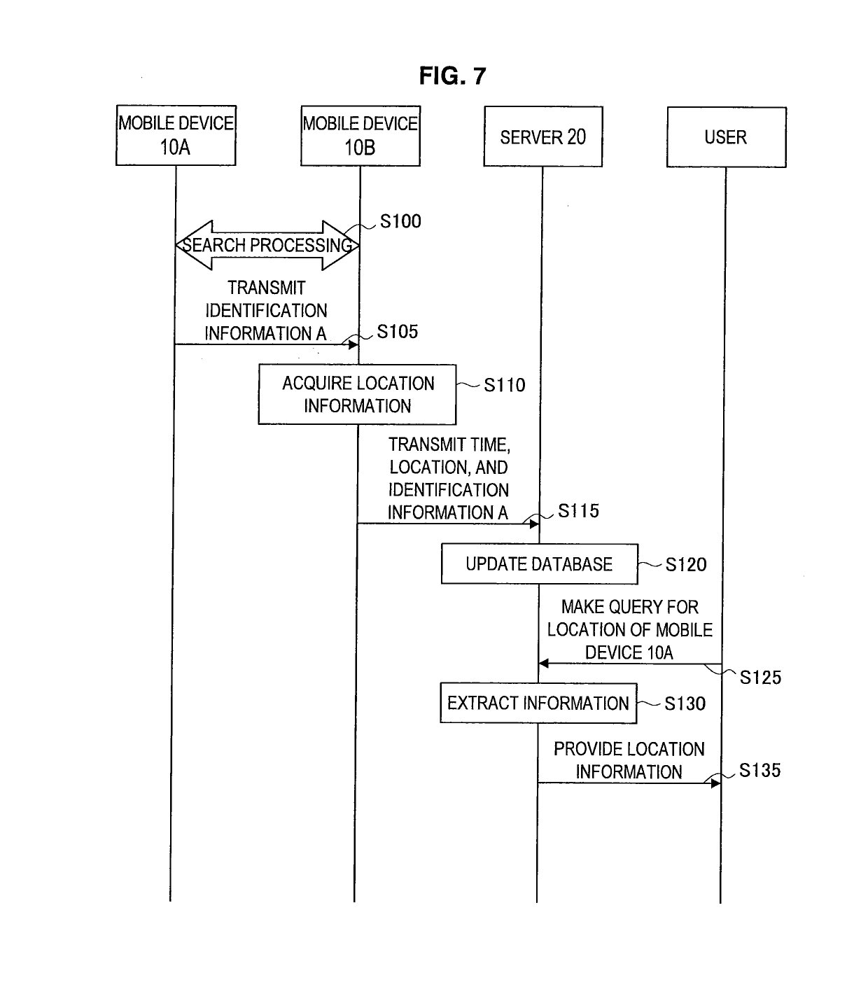

Next, with reference to FIG. 7, an operation example of the location information acquisition system according to the embodiment will be described. FIG. 7 is a sequence diagram showing operation performed by a location information acquisition system according to the embodiment.

First, search processing is performed between the first mobile device 10A and the second mobile device 10B, in which the first mobile device 10A and the second mobile device 10B each search for a device to be connected to (S100). For example, as described above, the search processing may be performed by the second mobile device 10B continually transmitting a signal that can be detected by the first mobile device 10A, and the first mobile device 10A detecting the signal.

When the first mobile device 10A detects the second mobile device 10B by performing the search processing, the first mobile device 10A transmits identification information A to the second mobile device 10B (S105). When receiving the identification information A, the second mobile device 10B acquires location information of a current point using the location information acquisition section 155 (S110). Then, the second mobile device 10B transmits the identification information A, the location information of the current point at the time point at which the identification information A is acquired, and the time at which the location information is acquired to the location information server 20 (S115).

When receiving the information from the second mobile device 10B, the location information server 20 updates a database based on the received information (S120).

Further, when a query for the location of the first mobile device 10A is made by the user to the location information server 20 (S125), the location information server 20 extracts the location information of the first mobile device 10A from the database (S130) and provides the user with the location information (S135).

### 3. Second Embodiment

### Example of Calculating Location Reliability

Next, there will be described a location information acquisition system according to a second embodiment of the present disclosure. In the present embodiment, the location information acquisition system further has a function of calculating reliability of location information. As suggested by the present disclosure, in the case of acquiring location information of a first mobile device 10A by a second mobile device 10B, the location information of a specific first mobile device 10A at the same time point may be acquired by multiple second mobile devices 10B with increase in the number of the second mobile devices 10B. Accordingly, it can be assumed that the location information acquired by a larger number of second mobile devices 10B is higher in the reliability of the location information. Hereinafter, a configuration for realizing such a function will be shown.

[3-1. Functional Configuration]

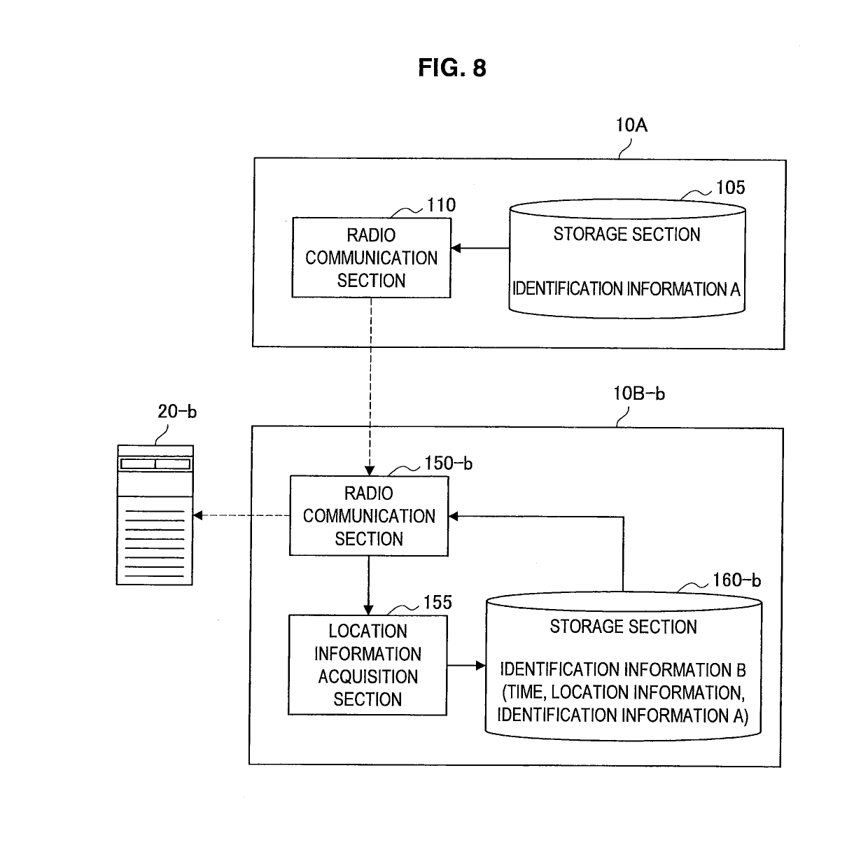

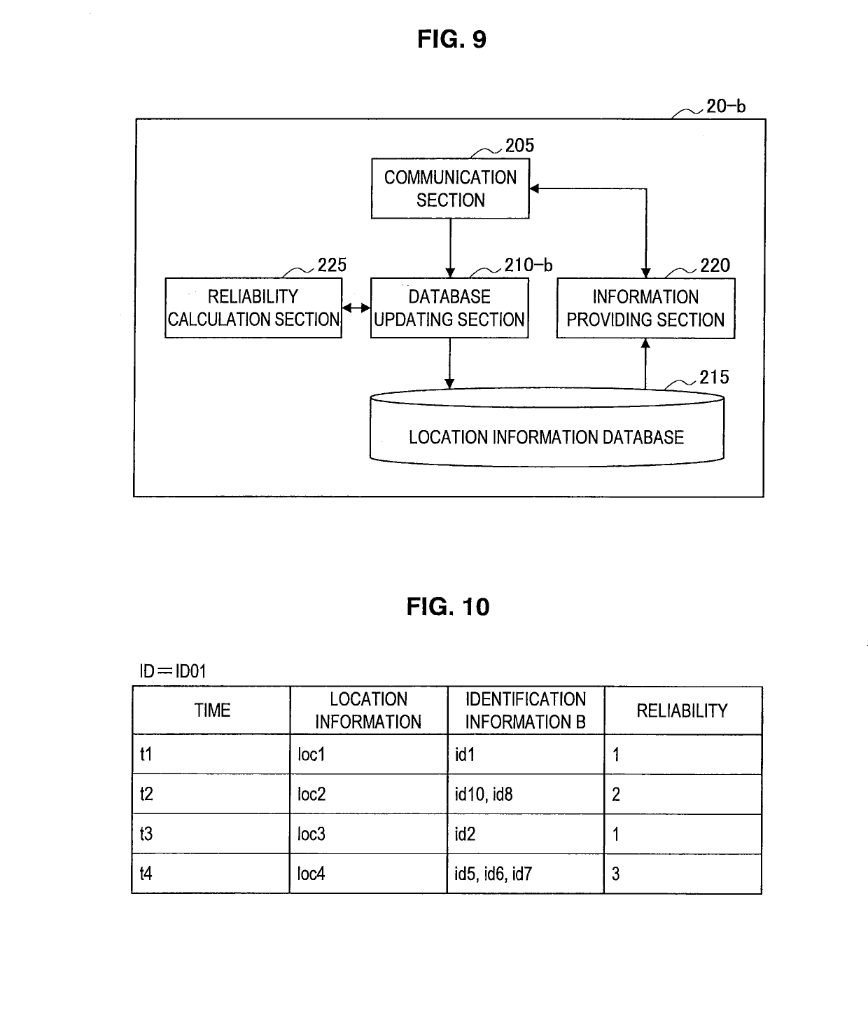

Here, with reference to FIGS. 8 to 10, there will be described a functional configuration of the location information acquisition system according to the second embodiment of the present disclosure. FIG. 8 is a block diagram showing a functional configuration of a mobile device according to the second embodiment of the present disclosure. FIG. 9 is a block diagram showing a functional configuration of a location information server according to the embodiment. FIG. 10 is a table showing an example of data stored in a location information database of the location information server according to the embodiment.

Note that, in the description below, the parts that are the same as those in the first embodiment will be denoted with the same reference numerals and the description thereof will be omitted, and the description will be made in detail on the differences.

((Second Mobile Device 10B-b)) A second mobile device 10B-b mainly includes a radio communication section 150-b, a location information acquisition section 155, and a storage section 160-b.

(Radio Communication Section 150-b)

The radio communication section 150-b is a communication device for establishing a wireless connection to an external device. The radio communication section 150-b can be connected to the first mobile device 10A, for example. The radio communication section 150-b can perform search processing for searching for the first mobile device 10A to be connected to. For example, the radio communication section 150-b can notify the first mobile device 10A of the presence of the second mobile device 10B by continually transmitting signals that can be detected by the first mobile device 10A. Then, the radio communication section 150-b can receive the identification information A from the first mobile device 10A to which the radio communication section 150-b is connected. Accordingly, the radio communication section 150-b can function as an identification information acquisition section which acquires the identification information A from the approaching first mobile device 10A. When receiving the identification information A from the first mobile device 10A, the radio communication section 150-b can notify the location information acquisition section 155 of the received identification information A.

Further, the radio communication section 150-b can also be connected to the location information server 20. The radio communication section 150-b can function as a transmission section which transmits the following in association with each other to the location information server 20, for example: the identification information A received from the first mobile device 10A; the location information acquired by the location information acquisition section 155 at the time at which the identification information A is received; time of the time point at which the location information is acquired; and identification information B for specifying the second mobile device 10B. The radio communication section 150-b may transmit the generated information to the location information server 20 each time the identification information A is received. Alternatively, the radio communication section 150-b may regularly transmit the generated multiple pieces of information collectively to the location information server 20.

((Location Information Server 20-b))

The location information server 20-b mainly includes a communication section 205, a database updating section 210-b, a location information database 215, an information providing section 220, and a reliability calculation section 225.

(Database Updating Section 210-b)

The database updating section 210-b has a function of updating information stored in the location information database 215. The database updating section 210-b can update data on location information of the first mobile device 10A based on information acquired from the second mobile device 10B via the communication section 205. Further, the database updating section 210-b can calculate the reliability with respect to the location information and can add the information of reliability to the database. For example, the database updating section 210-b may cause the reliability calculation section 225 to calculate the reliability of the location information and may update the location information database 215 each time information is acquired from the second mobile device 10B.

(Reliability Calculation Section 225)

The reliability calculation section 225 has a function of calculating reliability of location information. For example, it is desirable that the reliability has a larger value with increase in the possibility that the location information is correct. In the present embodiment, assigned to location information acquired from the second mobile device 10B is the identification information B for specifying the second mobile device 10B that has acquired the location information. The reliability calculation section 225 can calculate the reliability of the location information based on the acquired identification information B. For example, the reliability calculation section 225 may increase the reliability of the location information associated with a larger number of pieces of identification information B at approximately the same time.

For example, FIG. 10 shows an example of data stored in a location information database. The data shown here is location information on the first mobile device 10A having the identification information A of ID=ID01. For example, at time t1, location information loc1 is being acquired by the second mobile device 10B specified by id1. In this case, since the number of second mobile devices 10B that validate the location information loc1 is 1, the reliability can be set as 1. Further, at time t2, location information loc2 is being acquired by the second mobile devices 10B specified by id10 and id8, respectively. In this case, since the number of second mobile devices 10B that validate the location information loc1 is 2, the reliability can be set as 2.

[3-2. Operation Example]

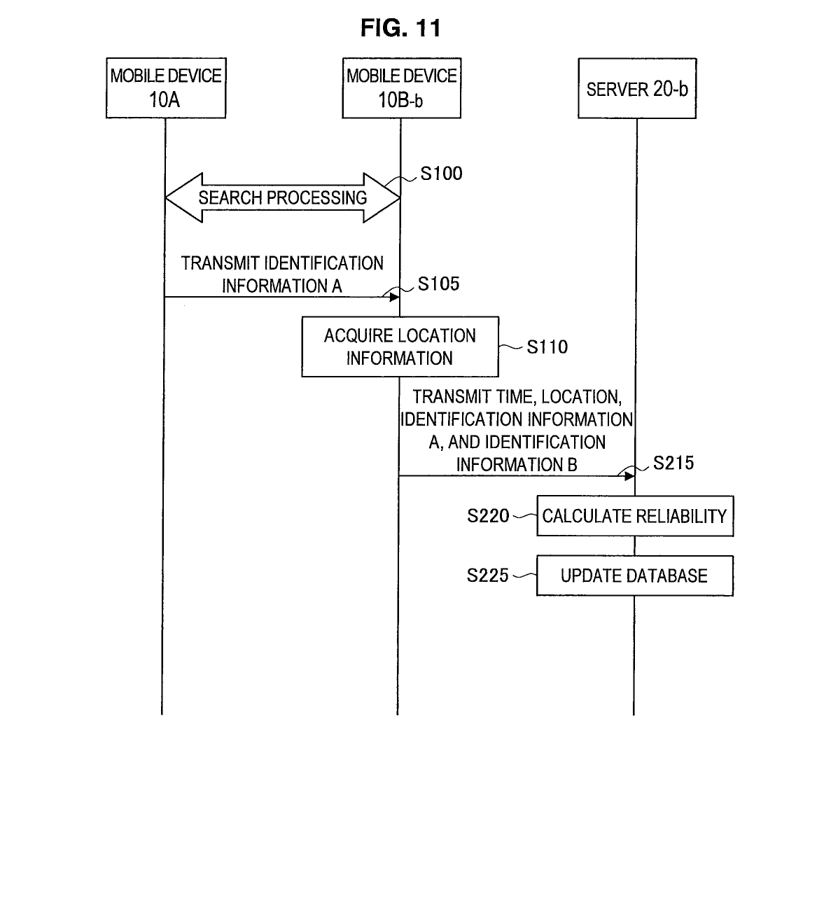

Next, with reference to FIG. 11, an operation example of the location information acquisition system according to the embodiment will be described. FIG. 11 is a sequence diagram showing operation performed by a location information acquisition system according to the embodiment.

The processing from Step S100 to Step S110 is the same as the processing of the first embodiment described using FIG. 7, and hence, the description thereof is omitted.

When location information is acquired in Step S110, the second mobile device 10B-b transmits the following to the location information server 20-b (S215): the identification information A; the location information of the current point at the time point at which the identification information A is acquired; the time at which the location information is acquired; and the identification information B for identifying the second mobile device 10B-b that has acquired the location information.

Here, the location information server 20-b calculates the reliability of the location information using the reliability calculation section 225 (S220). Then, the database is replaced with location information data containing information of the calculated reliability (S225).

### 4. Third Embodiment

### Example of Controlling Location Acquisition Area

Next, a location information acquisition system according to a third embodiment of the present disclosure will be described. In the present embodiment, the location information acquisition system further has a function of controlling a location acquisition area. As suggested by the present disclosure, in the case of acquiring location information of a first mobile device 10A by a second mobile device 10B, the first mobile device 10A can obtain the location information even when the first mobile device 10A itself does not have a positioning function. On the other hand, in the place where there is no second mobile device 10B, it is difficult for the first mobile device 10A to obtain the location information. Particularly in the initial stage following the start of a service, an area may occur in which there is no second mobile device 10B and it is difficult to perform position measurement. Accordingly, the present embodiment suggests a function of controlling a location information-acquirable area in order to solve this disadvantage.

[4-1. Functional Configuration]

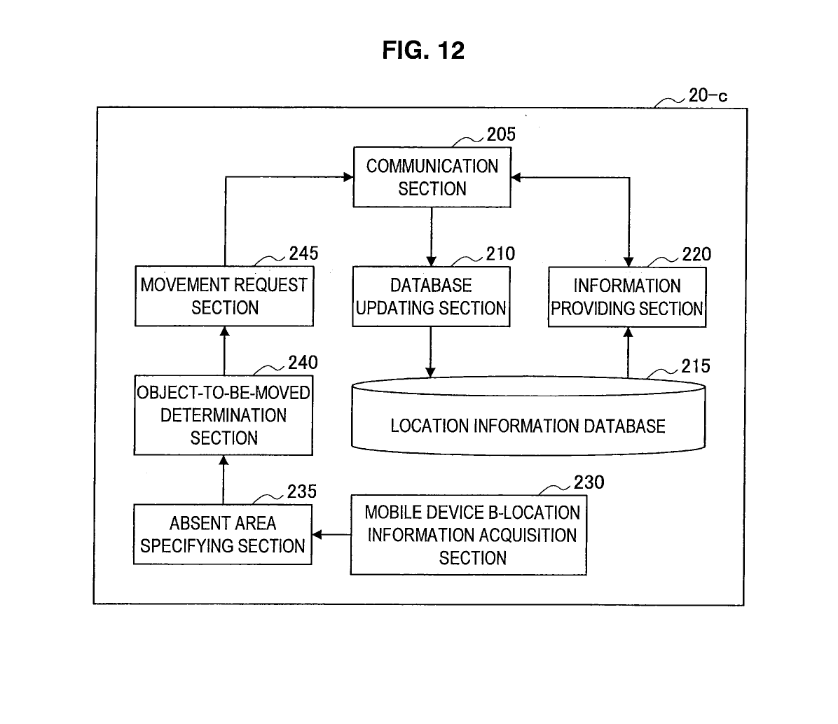

First, with reference to FIG. 12, there will be described a functional configuration of a location information server 20-c according to the embodiment. Note that the functional configurations of the first mobile device 10A and the second mobile device 10B are the same as those of the first embodiment or the second embodiment, and hence, the descriptions thereof are omitted.

((Location Information Server 20-c))

The location information server 20-c mainly includes a communication section 205, a database updating section 210, a location information database 215, an information providing section 220, a mobile device B-location information acquisition section 230, an absent area specifying section 235, an object-to-be-moved determination section 240, and a movement request section 245.

Note that the functions of the communication section 205, the database updating section 210, the location information database 215, and the information providing section 220 are the same as those of the first embodiment, and hence, the descriptions thereof are omitted.

(Mobile Device B-Location Information Acquisition Section 230)

The mobile device B-location information acquisition section 230 has a function of acquiring location information of the second mobile device 10B. The mobile device B-location information acquisition section 230 acquires the location information of the second mobile device 10B together with the time at which the location information is acquired. For example, the mobile device B-location information acquisition section 230 may acquire the location information of the second mobile device 10B by directly receiving, from the second mobile device 10B, the location information and the time at which the location information is acquired. Alternatively, the mobile device B-location information acquisition section 230 may acquire, via a communication path, location information of the second mobile device 10B that is uploaded by the second mobile device 10B to a server device which is a separate device therefrom.

(Absent Area Specifying Section 235)

The absent area specifying section 235 has a function of specifying an absent area in which there is no second mobile device 10B by using the location information of the second mobile device 10B. In the absent area, since no second mobile device 10B is present, it is difficult for the first mobile device 10A to acquire the location information. The absent area specifying section 235 can specify the absent area of a current time point in which there is no second mobile device 10B at the current time point. Further, the absent area specifying section 235 may also be capable of estimating an absent area of after the elapse of a predetermined time period. The absent area specifying section 235 can supply the object-to-be-moved determination section 240 with the information of the specified absent area.

(Object-to-be-Moved Determination Section 240)

The object-to-be-moved determination section 240 has a function of determining a second mobile device 10B to be moved to the absent area using the information of the absent area specified by the absent area specifying section 235 and the location information of the second mobile device 10B. It is desirable that the object-to-be-moved determination section 240 determines an object to be moved such that, after the target second mobile device 10B is moved to the absent area, the area in which the target second mobile device 10B has originally been present does not become an absent area. The object-to-be-moved determination section 240 can supply the movement request section 245 with the information of the determined object to be moved.

(Movement Request Section 245)

The movement request section 245 has a function of causing the second mobile device 10B that is to be moved, which is determined by the object-to-be-moved determination section 240, to transmit a request message for making a request for movement to the absent area.

[4-2. Operation Example]

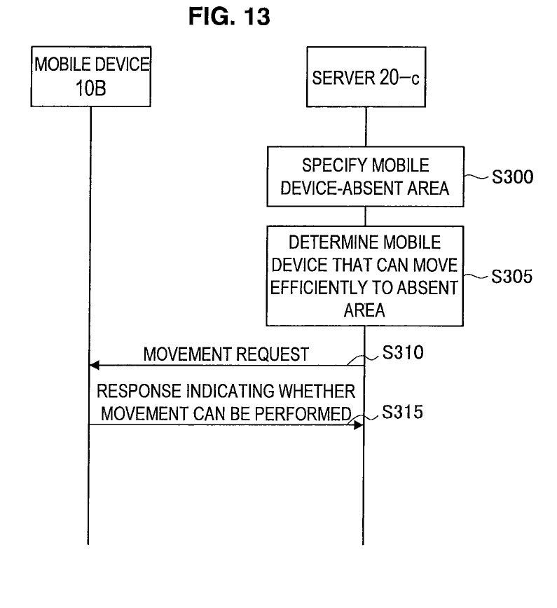

Next, with reference to FIG. 13, an operation example of the location information acquisition system according to the third embodiment of the present disclosure will be described. Note that only the points which are different from the first embodiment will be described in detail.

The absent area specifying section 235 of the location information server 20-c specifies an area in which the second mobile device 10B is absent (S300). Then, the object-to-be-moved determination section 240 determines a second mobile device 10B which can move efficiently to the specified absent area (S305). Here, it is desirable that object-to-be-moved determination section 240 determines an object to be moved in a manner that the possibility of creating a new absent area caused by the movement is low. Further, for example, in the case where the second mobile device 10B is mounted on a taxi, it is desirable that the object-to-be-moved determination section 240 determines an object to be moved from among the second mobile devices 10B mounted on vacant taxis.

The movement request section 245 transmits a movement request to the second mobile device 10B determined in Step S305 (S310). The second mobile device 10B can transmit a response indicating whether the movement can be performed (S315).

Whether the second mobile device 10B moves in accordance with the request is selectable. For example, in the case where the second mobile device 10B is mounted on a taxi, it is highly likely that the request to drive toward the absent area is accepted when the taxi is vacant. Further, in the case of applying the present technology to car-sharing, the possibility can be increased that a user accepts the request by providing the user driving toward the absent area with some kind of incentive such as cash-back rebate.

### 5. Fourth Embodiment

### Example of Providing Prediction Information of Location-Acquirable Area

Next, a location information acquisition system of a fourth embodiment of the present disclosure will be described. In the present embodiment, the location information acquisition system has a function of providing prediction information of a location-acquirable area. As described above, in the present technology, an area in which the second mobile device 10B is present represents the location-acquirable area in which the first mobile device 10A can acquire the location information. Accordingly, in the absent area in which there is no second mobile device 10B, it is difficult for the first mobile device 10A to acquire the location information. Particularly in the initial stage until a service is in widespread use, it is highly likely that an absent area may occur. Accordingly, the location information acquisition system according to the present embodiment can provide the prediction information of the location-acquirable area in which the location information can be acquired.

[5-1. Functional Configuration]

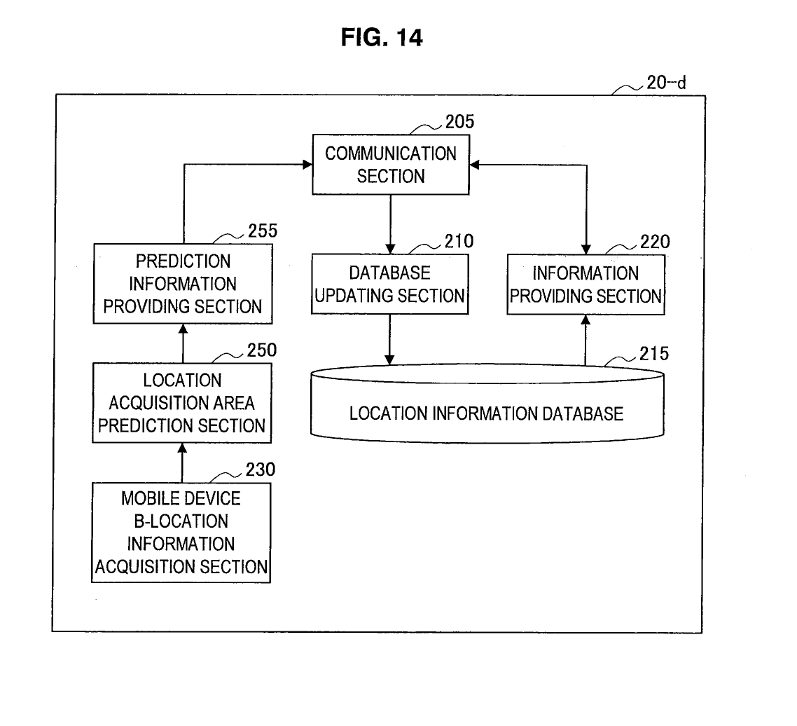

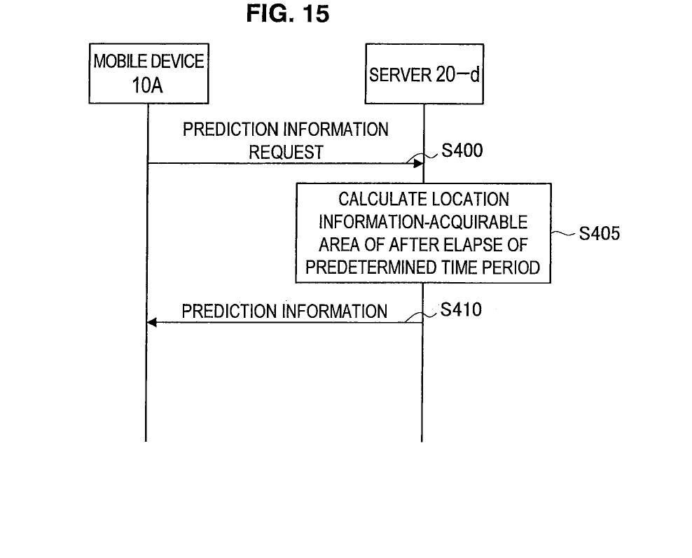

Here, there will be described a functional configuration of a location information server according to the fourth embodiment of the present disclosure. FIG. 14 is a block diagram showing a functional configuration of a location information server according to the fourth embodiment of the present disclosure.

((Location Information Server 20-d))

A location information server 20-d mainly includes a communication section 205, a database updating section 210, a location information database 215, an information providing section 220, a mobile device B-location information acquisition section 230, a location acquisition area prediction section 250, and a prediction information providing section 255.

(Location Acquisition Area Prediction Section 250)

The location acquisition area prediction section 250 has a function of predicting the location-acquirable area based on the location information of the second mobile device 10B. The location acquisition area prediction section 250 can generate prediction information of location-acquirable area of after the elapse of a designated predetermined time period. For example, the location acquisition area prediction section 250 can generate the prediction information in response to a request from the first mobile device 10A. In this case, the location acquisition area prediction section 250 can acquire information for specifying a location at which the location acquisition area prediction section 250 desires to obtain the prediction information from the first mobile device 10A, and information for specifying time at which the location acquisition area prediction section 250 desires to obtain the prediction information. The location acquisition area prediction section 250 generates the prediction information at the acquired location and time.

(Prediction Information Providing Section 255)

The prediction information providing section 255 has a function of providing the prediction information generated by the location acquisition area prediction section 250. The prediction information providing section 255 may also provide the prediction information by transmitting a display screen containing the generated prediction information via the communication section 205.

[5-2. Operation Example]

Next, with reference to FIG. 15, an operation example of the location information acquisition system according to the fourth embodiment of the present disclosure will be described. FIG. 15 is a sequence diagram showing operation performed by a location information acquisition system according to the embodiment.

First, the first mobile device 10A transmits, to the location information server 20-d, a prediction information request for making a request for prediction information (S400). The location acquisition area prediction section 250 of the location information server 20-d calculates the location-acquirable area of after the elapse of a designated predetermined time period in response to the request (S405). Then, the prediction information providing section 255 transmits the prediction information generated in Step S405 to the first mobile device 10A from which the request is sent (S410).

### 6. Fifth Embodiment

### Example of Using Temporary ID

[6-1. Outline]

Next, an outline of a location information acquisition system according to a fifth embodiment of the present disclosure will be described. In the embodiment, the location information acquisition system uses a temporary ID as identification information A for specifying a first mobile device 10A. As described above, in the present disclosure, a second mobile device 10B can acquire the identification information A for identifying the first mobile device 10A. Further, the second mobile device 10B acquires the identification information A when approaching the first mobile device 10A. Accordingly, in the case where a user of the second mobile device 10B acquires the identification information A of the first mobile device 10A by some kind of reason/means, leakage of privacy information related to the location of the user of the first mobile device 10A may occur. In order to deal with such situation, the location information acquisition system according to the present embodiment uses the temporary ID for temporarily identifying the first mobile device 10A.

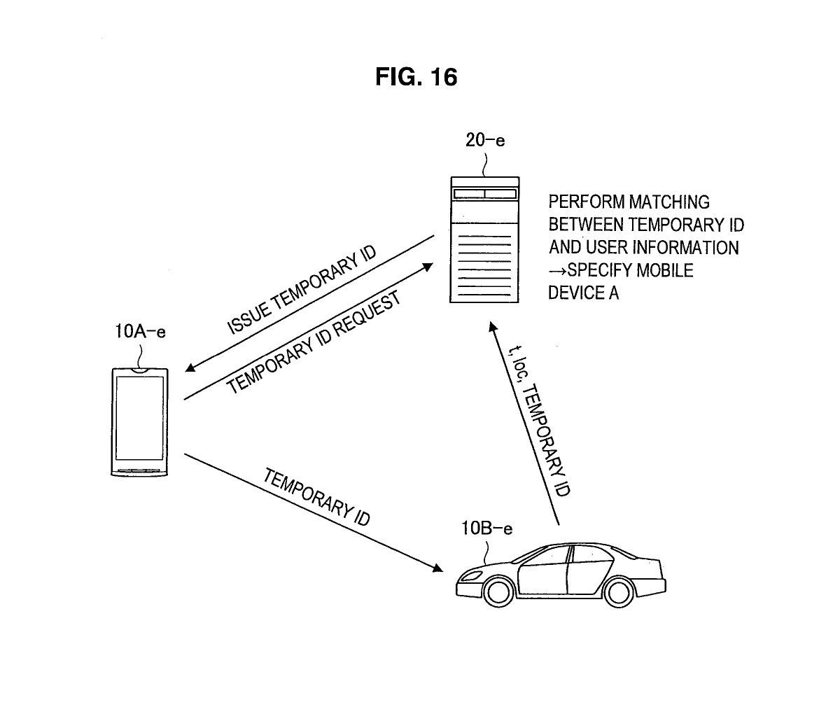

With reference to FIG. 16, an outline of a location information acquisition system according to the embodiment is shown. FIG. 16 is an explanatory diagram showing an outline of a location information acquisition system according to the fifth embodiment of the present disclosure.

The location information acquisition system according to the embodiment mainly includes a first mobile device 10A-e, a second mobile device 10B-e, and a location information server 20-e.

A temporary ID is assigned to the first mobile device 10A-e by the location information server 20-e in advance. Then, the first mobile device 10A-e transmits the temporary ID when approaching the second mobile device 10B-e. The second mobile device 10B-e transmits the received temporary ID, location information loc at a time point at which the temporary ID is received, and time t of the time point at which the location information is acquired, to the location information server 20-e. The location information server 20-e can refer to correlation information between the temporary ID and the identification information A, which is generated when issuing the temporary ID, and can specify the first mobile device 10A by specifying the identification information A using the temporary ID.

[6-2. Functional Configuration]

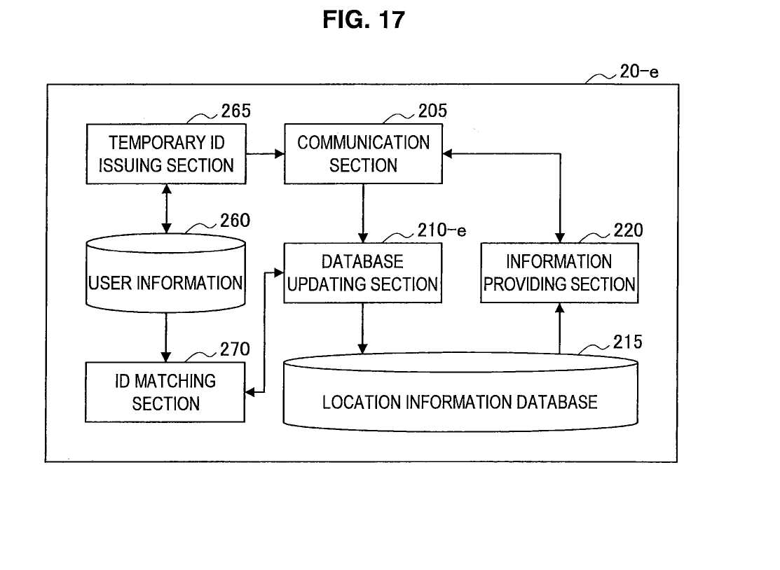

Here, with reference to FIG. 17, a functional configuration of the location information server 20-e for realizing the above functions will be described. FIG. 17 is a block diagram showing a functional configuration of a location information server according to the embodiment.

((Location Information Server 20-e))

The location information server 20-e mainly includes a communication section 205, a database updating section 210-e, a location information database 215, an information providing section 220, a user information database 260, a temporary ID issuing section 265, and an ID matching section 270.

(User Information Database 260)

The user information database 260 is a database for storing information related to a user of the location information acquisition system. The user information database 260 can include a user ID for identifying a user, for example. The identification information may be associated with the user and may also be used as the identification information A for identifying the first mobile device 10A. Alternatively, the identification information A for identifying the first mobile device 10A may be stored as a separate piece of information from the user ID. The user information database 260 can store a temporary ID issued by the temporary ID issuing section 265 in association with the user ID or the identification information A. The user information database 260 can hold multiple temporary ID's that are variations with the elapse of time. For example, the user information database 260 can store a temporary ID in association with information of time period in which the temporary ID is used. Further, the user information database 260 may include any other information related to the user. For example, the user information database 260 may include a name, a telephone number, an e-mail address, and the like of the user.

(Temporary ID Issuing Section 265)

The temporary ID issuing section 265 can issue a temporary ID with respect to the first mobile device 10A-e. The temporary ID issuing section 265 can notify the first mobile device 10A-e of the issued temporary ID, and can also update the temporary ID of the user information of the user information database 260. In this case, the temporary ID issuing section 265 may record information of the time period in which the temporary ID is used. Further, the temporary ID issuing section 265 can also collectively issue multiple temporary ID's. For example, the temporary ID issuing section 265 can collectively issue the following: ID1, which is a temporary ID to be used from 10 o'clock to 11 o'clock; ID2, which is a temporary ID to be used from 11 o'clock to 12 o'clock; and ID3, which is a temporary ID to be used from 12 o'clock to 13 o'clock. In this case, based on time of the time point at which a temporary ID is transmitted to the second mobile device 10B, the first mobile device 10A-e can select an appropriate temporary ID from among the issued temporary ID's and transmit it to the second mobile device 10B. The temporary ID issuing section 265 collectively issues the multiple temporary ID, and thus, the first mobile device 10A-e can reduce the traffic for acquiring the temporary ID from the location information server 20-e.

(Database Updating Section 210-e)

The database updating section 210-e has a function of updating a database based on information received from the second mobile device 10B-e via the communication section 205. The database updating section 210-e can add the information received from the second mobile device 10B-e to the location information database 215. In this case, the database updating section 210-e can acquire identification information A from the temporary ID received from the second mobile device 10B-e, and can record the identification information A, location information loc, and time t in the location information database 215. When receiving a temporary ID, the database updating section 210-e can supply the ID matching section 270 with information of the temporary ID. Then, the database updating section 210-e can update information of the location information database 215 using the identification information A acquired by the ID matching section 270.

(ID Matching Section 270)

The ID matching section 270 has a function of specifying the identification information A of the first mobile device 10A-e by performing matching using the information of the temporary ID supplied by the database updating section 210-e. When extracting the identification information A from the user information database 260, the ID matching section 270 can supply the database updating section 210-e with the extracted identification information A. Here, as described above, in the case where ID1, which is a temporary ID to be used from 10 o'clock to 11 o'clock, ID2, which is a temporary ID to be used from 11 o'clock to 12 o'clock, and ID3, which is a temporary ID to be used from 12 o'clock to 13 o'clock, are issued and the time at which the temporary ID is transmitted from the first mobile device 10A-e to the second mobile device 10B is around 11 o'clock, the ID matching section 270 may perform matching on the temporary ID to be used from 10 o'clock to 11 o'clock and on the temporary ID to be used from 11 o'clock to 12 o'clock.

### 7. Sixth Embodiment

### Example of Using Encoding

Next, a location information acquisition system according to a sixth embodiment of the present disclosure will be described. As described above, in the present disclosure, the identification information A of the first mobile device 10A can be acquired by the second mobile device 10B. Accordingly, it is desirable that security is taken into consideration regarding transmission of identification information. For example, the identification information A may be encoded and then transmitted.

[7-1. Functional Configuration]

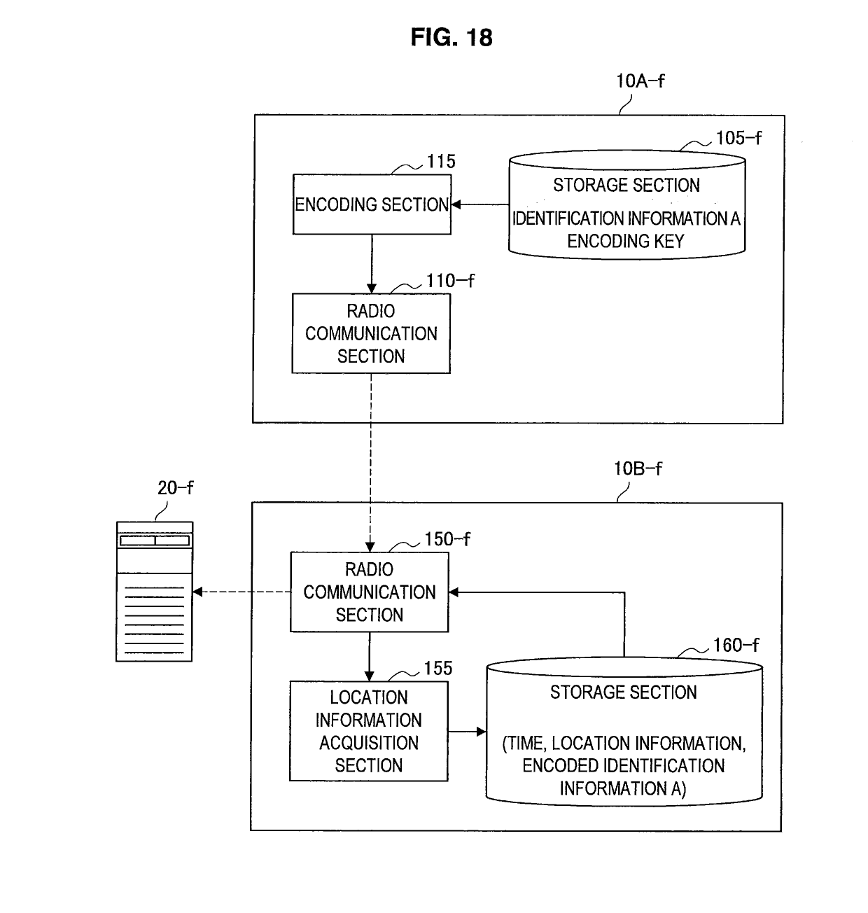

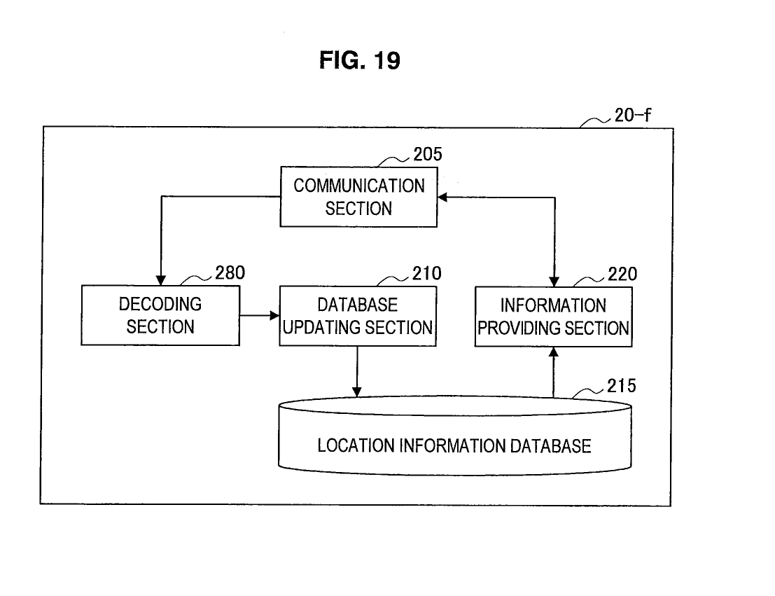

Here, with reference to FIG. 18 and FIG. 19, a functional configuration of a mobile device and a location information server according to the sixth embodiment of the present disclosure will be described. FIG. 18 is a block diagram showing a functional configuration of a mobile device according to the sixth embodiment of the present disclosure. FIG. 19 is a block diagram showing a functional configuration of a location information server according to the embodiment.

### ((First Mobile Device 10A-f))

First, a functional configuration of a first mobile device 10A-f will be described. The first mobile device 10A-f mainly includes a storage section 105-f, an encoding section 115, and a radio communication section 110-f.

(Storage Section 105-f)

The storage section 105-f can store the identification information A for identifying the first mobile device 10A and an encoding key used for encoding the identification information A. Note that this encoding key Kt changes with the elapse of time, and is synchronized with a key stored in a location information server 20-f. The storage section 105-f is a device for storing data, and can include a storage medium, a recording device for recording data in the storage medium, a reading device for reading the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

(Encoding Section 115)

The encoding section 115 has a function of encoding the identification information A. In this case, the encoding section 115 can encode the identification information A using the above-mentioned encoding key. Further, the encoding section 115 may also have a falsification detection function. For example, the encoding section 115 may simultaneously calculate a message authentication code (MAC) in order to guarantee the completeness of the identification information A, and may transmit MAC together with a cipher.

(Radio Communication Section 110-f)

The radio communication section 110-f is a communication device for establishing a wireless connection to an external device. The radio communication section 110-f can be connected to a second mobile device 10B-f, for example. In establishing a connection with the second mobile device 10B-f, the radio communication section 110-f can perform search processing for searching for the second mobile device 10B-f to be connected to. For example, the radio communication section 110-f can detect a signal for the search that is transmitted by the second mobile device 10B-f. The radio communication section 110-f can transmit the encoded identification information A to the detected second mobile device 10B-f. Note that the radio communication section 110-f can be connected to a mutually authenticated second mobile device 10B-f. Further, the radio communication section 110-f may be connected to the second mobile device 10B-f via an encoded communication path.

### ((Second Mobile Device 10B-f))

The second mobile device 10B-f mainly includes a radio communication section 150-f, a location information acquisition section 155, and a storage section 160-f.

(Radio Communication Section 150-f) The radio communication section 150-f is a communication device for establishing a wireless connection to an external device. The radio communication section 150-f can be connected to the first mobile device 10A-f, for example. The radio communication section 150-f can perform search processing for searching for the first mobile device 10A-f to be connected to. For example, the radio communication section 150-f can notify the first mobile device 10A-f of the presence of the second mobile device 10B-f by continually transmitting signals that can be detected by the first mobile device 10A-f. Then, the radio communication section 150-f can receive the encoded identification information A from the first mobile device 10A-f to which the radio communication section 150-f is connected. Accordingly, the radio communication section 150-f can function as an identification information acquisition section which acquires the encoded identification information A from the approaching first mobile device 10A-f. When receiving the encoded identification information A from the first mobile device 10A-f, the radio communication section 150-f can notify the location information acquisition section 155 of the received identification information A.

Further, the radio communication section 150-f can also be connected to the location information server 20-f. The radio communication section 150-f can function as a transmission section which transmits the following in association with each other, for example, to the location information server 20-f: the encoded identification information A received from the first mobile device 10A-f; the location information acquired by the location information acquisition section 155 at the time at which the identification information A is received; and time of the time point at which the location information is acquired. The radio communication section 150-f may transmit the generated information to the location information server 20-f each time the identification information A is received. Alternatively, the radio communication section 150-f may regularly transmit the generated multiple pieces of information collectively to the location information server 20-f. The radio communication section 150-f can be connected to a mutually authenticated location information server 20-f. Further, the radio communication section 150-f can be connected to the location information server 20-f via an encoded communication path.

(Storage section 160-f)

The storage section 160-f has a function of temporarily storing the encoded identification information A received from the first mobile device 10A-f, the location information at the time point at which the identification information A is acquired, and time at which the location information is acquired in association with each other. The storage section 160-f is a device for storing data, and can include a storage medium, a recording device for recording data in the storage medium, a reading device for reading the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

((Location Information Server 20-f))

Next, referring to FIG. 19, the location information server 20-f mainly includes a communication section 205, a decoding section 280, a database updating section 210, a location information database 215, and an information providing section 220.

(Decoding Section 280)

The decoding section 280 has a function of decoding the received identification information A using a key which is synchronized with the key that the first mobile device 10A-f used for the encoding and which changes with the elapse of time. The key changes with the elapse of time as described above, and an error may occur at a time point of switching of the key. Accordingly, in the case where the decoding using a specific key Kt is failed, it is desired that the decoding section 280 attempts to decode the identification information A using a key that is used immediately before or after the specific key Kt. Further, the decoding section 280 may have a function of verifying that the received identification information A is not falsified, by using the key used by the first mobile device 10A-f for calculating the message authentication code.

[7-2. Operation Example]

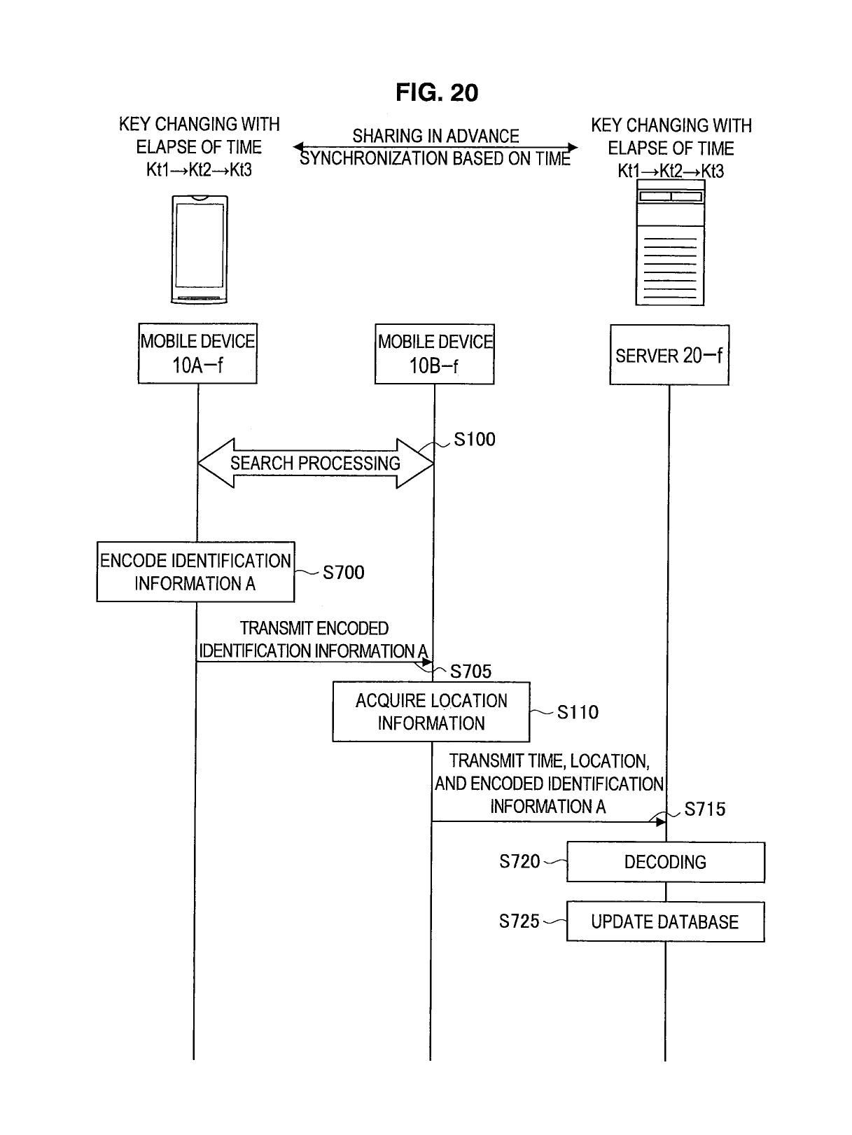

Next, with reference to FIG. 20, a location information acquisition system according to the sixth embodiment of the present disclosure will be described. FIG. 20 is a sequence diagram showing operation performed by a location information acquisition system according to the embodiment.

Referring to FIG. 20, a key Kt is shared in advance between the first mobile device 10A-f and the location information server 20-f, and the key changes with the elapse of time. The key Kt of the first mobile device 10A-f and the key Kt of the location information server 20-f are synchronized with each other based on time.

When the second mobile device 10B-f that is a connection destination is detected by the search processing of Step S100, the first mobile device 10A-f encodes the identification information A using the key Kt (S700). Then, the first mobile device 10A-f transmits the encoded identification information A to the second mobile device 10B-f (S705).

The second mobile device 10B-f acquires location information of a current point at the time point at which the identification information A is acquired (S110). Then, the second mobile device 10B-f transmits time t of the time point at which the location information is acquired in Step S110, the location information, and the encoded identification information A to the location information server 20-f (S715). The location information server 20-f decodes the received identification information A using the key Kt (S720). Then, the location information database is updated using the identification information A obtained by the decoding (S725).

### 8. Hardware Configuration

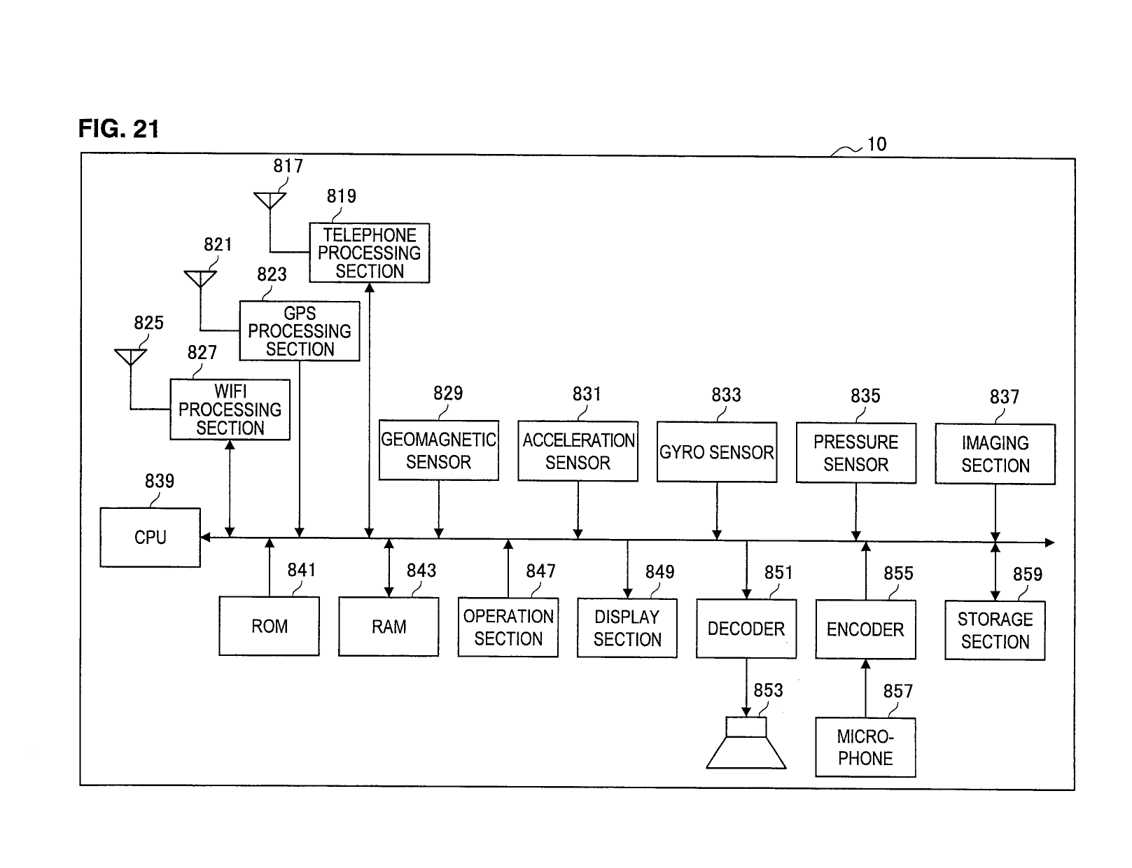

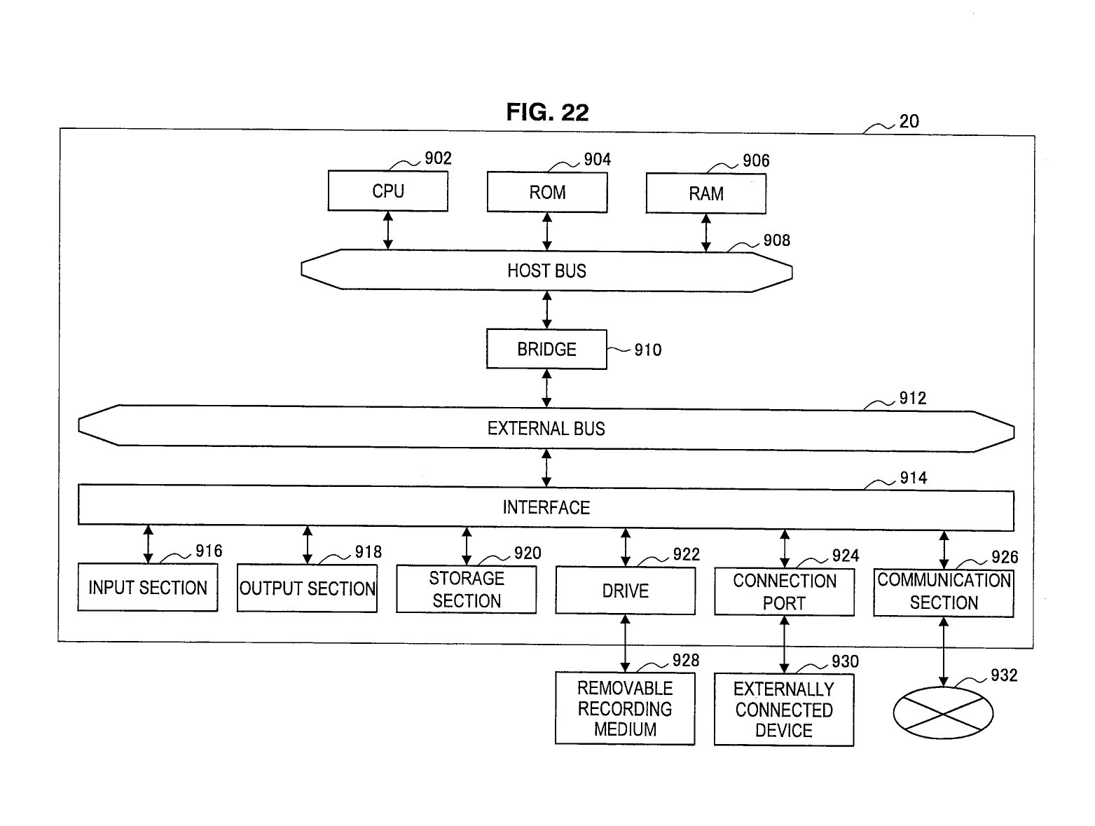

Next, there will be described an example of a hardware configuration for realizing each of the functions of the mobile device and the location information server according to the first to sixth embodiments of the present disclosure described above. FIG. 21 is a block diagram showing a hardware configuration example of the mobile device according to the first to sixth embodiments of the present disclosure. FIG. 22 is a block diagram showing a hardware configuration example of the location information server according to the first to sixth embodiments of the present disclosure.

Heretofore, in the first to sixth embodiments of the present disclosure, examples of functions of the first mobile device 10A, the second mobile device 10B, and the location information server 20 have been shown. Each of the above structural elements may be configured using general-purpose members or circuits, or may be configured using hardware specialized for the function of each structural element. Further, the function of each structural element may be realized by reading, by an arithmetic unit such as a CPU (Central Processing Unit), a control program from the storage medium such as a ROM (Read Only Memory) or a RAM (Random Access Memory) that stores the control program in which procedures for realizing those functions are written, and by interpreting and executing the program. Therefore, the configuration to be used can be changed appropriately in accordance with the technical level each time when the embodiment is carried out.

Note that there may be produced a computer program for realizing respective functions of the first mobile device 10A, the second mobile device 10B, and the location information server 20 according to the first to sixth embodiments of the present disclosure as described above, and the computer program can be implemented in a personal computer or the like. Further, there can also be provided a computer-readable recording medium having the computer program stored therein. Examples of the recording medium include a magnetic disk, an optical disc, a magneto-optical disk, and a flash memory. Further, the computer program may be distributed via a network, without using the recording medium, for example. Hereinafter, there will be described an example of a hardware configuration for realizing the functions described above.

### ((Mobile Device 10))

First, an example of a configuration of a mobile device 10 will be described. Note that the mobile device 10 is a concept including a first mobile device 10A and a second mobile device 10B. Referring to FIG. 21, the mobile device 10 includes, for example, a telephone network antenna 817, a telephone processing section 819, a GPS antenna 821, a GPS processing section 823, a WiFi antenna 825, a WiFi processing section 827, a geomagnetic sensor 829, an acceleration sensor 831, a gyro sensor 833, a pressure sensor 835, an imaging section 837, a CPU (Central Processing Unit) 839, a ROM (Read Only Memory) 841, a RAM (Random Access Memory) 843, an operation section 847, a display section 849, a decoder 851, a speaker 853, an encoder 855, a microphone 857, and a storage section 859. Note that the hardware configuration shown here is merely an example, and some of the structural elements may be omitted. Further, the hardware configuration may of course include structural elements other than the above-mentioned structural elements.

### (Telephone Network Antenna 817)

The telephone network antenna 817 is an example of an antenna having a function of establishing a connection via radio waves with a mobile phone network for telephone call and data communication. The telephone network antenna 817 can supply the telephone processing section 819 with a telephone call signal received through the mobile phone network.

### (Telephone Processing Section 819)

The telephone processing section 819 has a function of performing various types of signal processing on a signal transmitted/received by the telephone network antenna 817. For example, the telephone processing section 819 can perform various types of processing on an audio signal which is input through the microphone 857 and encoded by the encoder 855, and can supply the telephone network antenna 817 with the audio signal. Further, the telephone processing section 819 can perform various types of processing on an audio signal supplied by the telephone network antenna 817, and can supply the decoder 851 with the audio signal.

### (GPS Antenna 821)

The GPS antenna 821 is an example of an antenna which receives a signal from a positioning satellite. The GPS antenna 821 is capable of receiving GPS signals from multiple GPS satellites, and inputs the received GPS signals to the GPS processing section 823.

### (GPS Processing Section 823)

The GPS processing section 823 is an example of a calculation section which calculates location information based on the signals received from the positioning satellites. The GPS processing section 823 calculates current location information based on the multiple GPS signals input from the GPS antenna 821, and outputs the calculated location information. To be specific, the GPS processing section 823 calculates positions of the respective GPS satellites based on the orbital data of the GPS satellites, and calculates distances from the respective GPS satellites to the mobile device 10 based on the differences between transmission time and reception time of the GPS signals. Then, based on the calculated positions of the respective GPS satellites and the calculated distances from the respective GPS satellites to the mobile device 10, a current three-dimensional position can be calculated. Note that the orbital data of GPS satellites used here may be included in the GPS signals, for example. Alternatively, the orbital data of GPS satellites may be acquired from an external server via the communication antenna 825.

### (WiFi Antenna 825)

The WiFi antenna 825 is an antenna having a function of transmitting/receiving a communication signal to/from a wireless local area network (LAN) communication network in accordance with the WiFi specification, for example. The WiFi antenna 825 can supply the WiFi processing section 827 with the received signal.

### (WiFi Processing Section 827)

The WiFi processing section 827 has a function of performing various types of signal processing on the signal supplied by the WiFi antenna 825. The WiFi processing section 827 can supply the CPU 839 with a digital signal generated from the supplied analog signal.

### (Geomagnetic Sensor 829)

The geomagnetic sensor 829 is a sensor for detecting geomagnetism as a voltage value. The geomagnetic sensor 829 may be a 3-axis geomagnetic sensor which detects geomagnetism in the X-axis direction, the Y-axis direction, and the Z-axis direction. The geomagnetic sensor 829 can supply the CPU 839 with the detected geomagnetic data.

### (Acceleration Sensor 831)

The acceleration sensor 831 is a sensor for detecting acceleration as a voltage value. The acceleration sensor 831 may be a 3-axis acceleration sensor which detects acceleration along the X-axis direction, acceleration along the Y-axis direction, and acceleration along the Z-axis direction. The acceleration sensor 831 can supply the CPU 839 with the detected acceleration data.

### (Gyro Sensor 833)

The gyro sensor 833 is a measuring instrument for detecting an angle or an angular velocity of an object. The gyro sensor 833 may be a 3-axis gyro sensor which detects a variable velocity (angular velocity) of the rotation angle around each of the X-axis, the Y-axis, and the Z-axis as a voltage value. The gyro sensor 833 can supply the CPU 839 with the detected angular velocity data.

### (Pressure Sensor 835)

The pressure sensor 835 is a sensor for detecting the surrounding pressure as a voltage value. The pressure sensor 835 detects a pressure at a predetermined sampling frequency, and can supply the CPU 839 with the detected pressure data.

### (Imaging Section 837)

The imaging section 837 has a function of capturing a still image or a moving image via a lens in accordance with control of the CPU 839. The imaging section 837 may cause the storage section 859 to store the captured image.

### (CPU 839)

The CPU 839 functions as an arithmetic processing unit and a control unit, and controls the overall operation inside the mobile device 10 in accordance with various programs. Further, the CPU 839 may be a microprocessor. The CPU 839 can realize various functions in accordance with various programs.

### (ROM 841, RAM 843)

The ROM 841 can store programs and arithmetic parameters used by the CPU 839. The RAM 843 can temporarily store programs used during execution of the CPU 839 and parameters that appropriately change during the execution thereof.

### (Operation Section 847)

The operation section 847 has a function of generating an input signal used by a user for performing a desired operation. For example, the operation section 847 may be configured from, for example, an input section for inputting information by the user, such as a touch sensor, a mouse, a keyboard, a button, a microphone, a switch, and a lever, and an input control circuit which generates an input signal based on the input by the user and outputs the generated input signal to the CPU 839.

### (Display Section 849)

The display section 849 is an example of an output device, and may be a liquid crystal display (LCD) device, an organic light emitting diode (OLED) display device, or the like. The display section 849 displays a screen to the user, and thereby being able to provide information.

### (Decoder 851, Speaker 853)

The decoder 851 has a function of performing decoding, analog conversion, and the like of input data in accordance with the control of the CPU 839. The decoder 851 can perform decoding, analog conversion, and the like of audio data input through the telephone network antenna 817 and the telephone processing section 819, and can output an audio signal to the speaker 853, for example. Further, the decoder 851 can perform decoding, analog conversion, and the like of audio data input through the WiFi antenna 825 and the WiFi processing section 827, and can output an audio signal to the speaker 853, for example. The speaker 853 can output the audio based on the audio signal supplied from the decoder 851.

### (Encoder 855, Microphone 857)

The encoder 855 has a function of performing digital conversion, encoding, and the like of input data in accordance with the control of the CPU 839. The encoder 855 can perform digital conversion, encoding, and the like of an audio signal input from the microphone 857, and can output audio data. The microphone 857 can collect audio and output the audio as an audio signal.

### (Storage Section 859)

The storage section 859 is a device for storing data, and can include a storage medium, a recording device for recording data in the storage medium, a reading device for reading the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

### ((Location Information Server 20))

Next, with reference to FIG. 22, a hardware configuration example of the location information server 20 according to the first to sixth embodiments of the present disclosure will be described. As shown in FIG. 22, the hardware mainly includes a CPU 902, a ROM 904, a RAM 906, a host bus 908, and a bridge 910. In addition, the hardware includes an external bus 912, an interface 914, an input section 916, an output section 918, a storage section 920, a drive 922, a connection port 924, and a communication section 926. Note that “CPU” is an abbreviation for “central processing unit”. Further, “ROM” is an abbreviation for “read only memory”. Still further, “RAM” is an abbreviation for “random access memory”.

The CPU 902 functions as an arithmetic processing unit or a control unit, and controls the overall operation or a part of the operation of each structural element based on various programs recorded in the ROM 904, the RAM 906, the storage section 920, or a removable recording medium 928. The ROM 904 is a unit for storing a program to be read by the CPU 902, data used for calculation, and the like. The RAM 906 temporarily or permanently stores a program to be read by the CPU 902, various parameters that appropriately change when executing the program, and the like.

Those structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input section 916 may be a remote control that can transmit a control signal by using an infrared ray or other radio waves.

The output section 918 is, for example, a display device such as a CRT, an LCD, a PDP, or an ELD, an audio output device such as a speaker or headphones, a printer, a mobile phone, or a facsimile, that can visually or auditorily notify a user of acquired information. Note that, “CRT” is an abbreviation for “cathode ray tube”. Further, “LCD” is an abbreviation for “liquid crystal display”. Still further, “PDP” is an abbreviation for “plasma display panel”. Also, “ELD” is an abbreviation for “electro-luminescence display”.

The storage section 920 is a device for storing various data. The storage section 920 is, for example, a magnetic storage device such as an HDD, a semiconductor storage device, an optical storage device, or a magneto-optical storage device. Note that “HDD” is an abbreviation for “hard disk drive”.

The drive 922 is a device that reads information recorded on the removal recording medium 928 such as a magnetic disk, an optical disc, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an IC card having a non-contact IC chip mounted thereon or an electronic device. Note that “IC” is an abbreviation for “integrated circuit”.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Note that “USB” is an abbreviation for “universal serial bus”. Also, “SCSI” is an abbreviation for “small computer system interface”.

The communication section 926 is a communication device to be connected to the network 932, and is, for example, a communication card for a wired or wireless LAN, Bluetooth (registered trademark), or WUSB, an optical communication router, an ADSL router, or various communication modems. The network 932 connected to the communication section 926 is configured from a wire-connected or wirelessly connected network, and is the Internet, a home-use LAN, infrared communication, visible light communication, broadcasting, or satellite communication, for example. Note that “LAN” is an abbreviation for “local area network”. Also, “WUSB” is an abbreviation for “wireless USB”. Furthermore, “ADSL” is an abbreviation for “asymmetric digital subscriber line”.

### 9. Conclusion

Heretofore, descriptions have been made with reference to the multiple preferred embodiments of the present disclosure. For example, as described in the first embodiment, the second mobile device 10B acquires the location information of the first mobile device 10A and uploads the location information to the location information server 20, and thus the reliability of the location information can be enhanced. In this case, the second mobile device 10B, which is a separate device from the first mobile device 10A that wants the location information, acquires the location information, and therefore it becomes difficult for the user of the first mobile device 10A to falsify the location information. As a result thereof, the reliability of the location information is enhanced.

Further, when the location information is acquired by the second mobile device 10B, there is an advantage in that the maintenance of the devices is easier compared to the case where devices are installed at infrastructure facilities such as a traffic light, a telegraph pole, a road, and a building. In particular, if second mobile devices 10B are mounted on taxis, vehicles for car-sharing, buses, trains, and the like, multiple vehicles can be gathered in a garage, and therefore, it is not necessary that maintenance workers go round multiple installation locations for performing maintenance. Further, in the case of installing devices at infrastructure facilities, it is necessary to perform adjustment for the use at each location. However, according to the present technology in which the mobile devices are used, there is an advantage in that the system can be introduced at own responsibility of, for example, a taxi operating company.

Further, as described in the second embodiment, the reliability of the location information may be expressed in a numerical value and provided. In this case, it can be considered that the location information validated by multiple second mobile devices 10B has high reliability. In this way, the reliability of the location information can be grasped as a numerical value.

Further, as described in the third embodiment, a location acquisition area may be controlled. As described above, according to the technology of the present disclosure, the location information of the first mobile device 10A is acquired by the second mobile device 10B. Accordingly, the absent area in which there is no second mobile device 10B is an area in which it is difficult for the first mobile device 10A to acquire the location information. Therefore, the occurrence of the absent area can be reduced by controlling the location of the second mobile device 10B.

Further, as described in the fourth embodiment, the prediction information of the location-acquirable area may be provided. As described above, according to the present technology, an absent area may occur particularly in the initial stage of introducing the system. Accordingly, it is preferred that the prediction information of the location-acquirable area be provided.

Further, as described in the fifth embodiment, the temporary ID may be used for specifying the first mobile device 10A. The identification information A of the first mobile device 10A is personal information of a user. Therefore, it is necessary to pay attention in handling the identification information A from the viewpoint of protecting the user's privacy. Accordingly, the present disclosure suggests using a temporary ID. The time-limited temporary ID is issued, and this can make it difficult to track the user.

Further, as described in the sixth embodiment, it is also preferred to encode the identification information A which is used for specifying the first mobile device 10A, and to transmit the encoded identification information A. In the sixth embodiment, the identification information A is encoded, but the present technology is not limited thereto. For example, the temporary ID used in the fifth embodiment may be encoded and then transmitted, and thus, the security can be further enhanced.

It should be understood by those skilled in the art that various modifications, combinations, sub-combinations and alterations may occur depending on design requirements and other factors insofar as they are within the scope of the appended claims or the equivalents thereof.

Note that, in the present specification, the steps written in the sequence diagram may of course be processed in chronological order in accordance with the stated order, but may not necessarily be processed in the chronological order, and may be processed individually or in a parallel manner. It is needless to say that, in the case where the steps are processed in the chronological order, the order of the steps may be changed appropriately according to circumstances.

Additionally, the present technology may also be configured as below.

(1) A mobile device including:

an identification information acquisition section which acquires first identification information from an approaching mobile device;

a location information acquisition section which acquires location information of a current point at a time point at which the first identification information is acquired; and

a transmission section which transmits the first identification information and the location information in association with each other to an external device.

(2) The mobile device according to (1),

wherein the transmission section transmits, together with the first identification information and the location information, second identification information which identifies the mobile device that has acquired the location information to the external device.

(3) The mobile device according to (1) or (2),

wherein the transmission section transmits the first identification information and the location information to the external device each time the first identification information is acquired.

(4) The mobile device according to any one of (1) to (3),

wherein the transmission section collectively transmits a plurality of pieces of the first identification information and a plurality of pieces of the location information to the external device.

(5) The mobile device according to any one of (1) to (4),

wherein the identification information acquisition section acquires the first identification information which is encoded using a key that changes with elapse of time, and

wherein the key is shared with the external device, and the first identification information is decoded by the external device.

(6) The mobile device according to any one of (1) to (5),

wherein the transmission section transmits the first identification information and the location information to the external device which is mutually authenticated therewith.

(7) The mobile device according to any one of (1) to (6),

wherein the transmission section transmits the first identification information and the location information to the external device which is connected thereto via an encoded communication path.

(8) An information processing device including:

a reception section which receives first identification information that is acquired by a second mobile device from an approaching first mobile device and that identifies the first mobile device, and location information of a time point at which the first identification information is acquired by the second mobile device; and

a recording section which records the received first identification information and the received location information.

(9) The information processing device according to (8),

wherein the reception section further receives second identification information that identifies the second mobile device, and

wherein the recording section further records the second identification information.

(10) The information processing device according to (9), further including

a reliability calculation section which calculates reliability of the location information of the first mobile device based on the second identification information.

(11) The information processing device according to (10),

wherein the reliability calculation section increases the reliability of the location information that is associated with a plurality of pieces of the second identification information at approximately a same time.

(12) The information processing device according to any one of (8) to (11), further including:

an absent area specifying section which specifies an absent area in which the second mobile device is absent based on location information of the second mobile device;

a target determination section which determines the second mobile device to be moved to the absent area based on the location information of the second mobile device; and

a request section which makes a request to the determined second mobile device to move to the absent area.

(13) The information processing device according to any one of (8) to (12), further including

a prediction information providing section which provides prediction information that predicts a location information-acquirable area of after elapse of a predetermined time period based on location information of the second mobile device.

(14) The information processing device according to any one of (8) to (13),

wherein the first identification information is encoded by the second mobile device using a key that changes with elapse of time, and

wherein the information processing device further includes a decoding section which decodes the first identification information using the key that is synchronized with the second mobile device.

(15) The information processing device according to any one of (8) to (14), further including:

an identification information issuing section which issues the first identification information that is temporary and that is valid for a predetermined period to the first mobile device; and

a matching section which specifies the first mobile device based on the temporary first identification information.

(16) The information processing device according to any one of (8) to (15), further including

a location information providing section which provides the recorded location information as location information of the first mobile device.

(17) The information processing device according to (16),

wherein the location information providing section provides the location information using a map display screen in which the recorded location information is superimposed on a map.

(18) A location information acquisition method including:

acquiring first identification information from an approaching mobile device;

acquiring location information of a current point at a time point at which the first identification information is acquired; and

transmitting the first identification information and the location information in association with each other to an external device.

(19) A location information acquisition system including:

a first mobile device;

a second mobile device including
an identification information acquisition section which acquires first identification information from the first mobile device that is approaching,
a location information acquisition section which acquires location information of a current point at a time point at which the first identification information is acquired, and
a transmission section which transmits the first identification information and the location information in association with each other; and

an information processing device including
a reception section which receives the first identification information and the location information transmitted by the second mobile device, and
a recording section which records the first identification information and the location information.
   (20) A program for causing a computer to function as a mobile device including

an identification information acquisition section which acquires first identification information from an approaching mobile device,

a location information acquisition section which acquires location information of a current point at a time point at which the first identification information is acquired, and

a transmission section which transmits the first identification information and the location information in association with each other to an external device.

The present disclosure contains subject matter related to that disclosed in Japanese Priority Patent Application JP 2011-233625 filed in the Japan Patent Office on Oct. 25, 2011, the entire content of which is hereby incorporated by reference.

What is claimed is:

1. A mobile device comprising:
an identification information acquisition section which acquires first identification information from an approaching mobile device;
a location information acquisition section which acquires location information of a current point at a time point at which the first identification information is acquired; and
a transmission section which transmits the first identification information and the location information in association with each other to an external device.

2. The mobile device according to claim 1,
wherein the transmission section transmits, together with the first identification information and the location information, second identification information which identifies the mobile device that has acquired the location information to the external device.

3. The mobile device according to claim 1,
wherein the transmission section transmits the first identification information and the location information to the external device each time the first identification information is acquired.

4. The mobile device according to claim 1,
wherein the transmission section collectively transmits a plurality of pieces of the first identification information and a plurality of pieces of the location information to the external device.

5. The mobile device according to claim 1,
wherein the identification information acquisition section acquires the first identification information which is encoded using a key that changes with elapse of time, and
wherein the key is shared with the external device, and the first identification information is decoded by the external device.

6. The mobile device according to claim 1,
wherein the transmission section transmits the first identification information and the location information to the external device which is mutually authenticated therewith.

7. The mobile device according to claim 1,
wherein the transmission section transmits the first identification information and the location information to the external device which is connected thereto via an encoded communication path.

8. An information processing device comprising:
a reception section which receives first identification information that is acquired by a second mobile device from an approaching first mobile device and that identifies the first mobile device, and location information of a time point at which the first identification information is acquired by the second mobile device; and
a recording section which records the received first identification information and the received location information.

9. The information processing device according to claim 8,
wherein the reception section further receives second identification information that identifies the second mobile device, and
wherein the recording section further records the second identification information.

10. The information processing device according to claim 9, further comprising
a reliability calculation section which calculates reliability of the location information of the first mobile device based on the second identification information.

11. The information processing device according to claim 10,
wherein the reliability calculation section increases the reliability of the location information that is associated with a plurality of pieces of the second identification information at approximately a same time.

12. The information processing device according to claim 8, further comprising:
an absent area specifying section which specifies an absent area in which the second mobile device is absent based on location information of the second mobile device;
a target determination section which determines the second mobile device to be moved to the absent area based on the location information of the second mobile device; and
a request section which makes a request to the determined second mobile device to move to the absent area.

13. The information processing device according to claim 8, further comprising
a prediction information providing section which provides prediction information that predicts a location information-acquirable area of after elapse of a predetermined time period based on location information of the second mobile device.

14. The information processing device according to claim 8,
wherein the first identification information is encoded by the second mobile device using a key that changes with elapse of time, and
wherein the information processing device further includes a decoding section which decodes the first identification information using the key that is synchronized with the second mobile device.

15. The information processing device according to claim 8, further comprising:
an identification information issuing section which issues the first identification information that is temporary and that is valid for a predetermined period to the first mobile device; and
a matching section which specifies the first mobile device based on the temporary first identification information.

16. The information processing device according to claim 8, further comprising
a location information providing section which provides the recorded location information as location information of the first mobile device.

17. The information processing device according to claim 16,
wherein the location information providing section provides the location information using a map display screen in which the recorded location information is superimposed on a map.

18. A location information acquisition method comprising:
acquiring first identification information from an approaching mobile device;
acquiring location information of a current point at a time point at which the first identification information is acquired; and
transmitting the first identification information and the location information in association with each other to an external device.

19. A location information acquisition system comprising:
a first mobile device;
a second mobile device including
an identification information acquisition section which acquires first identification information from the first mobile device that is approaching,
a location information acquisition section which acquires location information of a current point at a time point at which the first identification information is acquired, and
a transmission section which transmits the first identification information and the location information in association with each other; and
an information processing device including
a reception section which receives the first identification information and the location information transmitted by the second mobile device, and
a recording section which records the first identification information and the location information.

20. A program for causing a computer to function as a mobile device including
an identification information acquisition section which acquires first identification information from an approaching mobile device,
a location information acquisition section which acquires location information of a current point at a time point at which the first identification information is acquired, and
a transmission section which transmits the first identification information and the location information in association with each other to an external device.
